(19) United States
(12) Patent Application Publication
(10) Pub. No.: US 2025/0221425 A1
(43) Pub. Date: Jul. 10, 2025

(54) PLANT-BASED CHEESE PRODUCT AND METHOD OF MAKING A PLANT-BASED CHEESE PRODUCT

(71) Applicant: Kraft Foods Group Brands LLC, Chicago, IL (US)

(72) Inventors: Judith Gulten Moca, Palatine, IL (US); Allison M. Hibnick, Buffalo Grove, IL (US); Isin Karakaplan, Northbrook, IL (US); Stacie Lynn Dobson, Point Edward (CA); Alejandro G. Marangoni, Guelph (CA)

(21) Appl. No.: 18/698,946

(22) PCT Filed: Oct. 7, 2022
(86) PCT No.: PCT/US2022/046063

§ 371 Date: Apr. 5, 2024

Related U.S. Application Data
(63) Continuation-in-part of application No. 17/733,732, filed on Apr. 29, 2022.
(60) Provisional application No. 63/253,456, filed on Oct. 7, 2021.

(51) Int. Cl. A23C 20/02; A23L 29/231

(52) U.S. Cl. CPC A23C 20/025; A23L 29/231

(57) ABSTRACT

Provided are plant-based cheese products having a protein content comparable to dairy-based cheeses. Plant-based cheese products are also provided having characteristics consistent with consumer expectations for a dairy-based cheese, such as melting and stretching at cooking temperatures. The plant-based cheese products include a combination of a plantbased protein in an amount of about 10 wt % to about 25 wt % crude protein, a waxy starch, and a fat. The waxy starch is at least partially gelatinized in the plant-based cheese product.

### CROSS REFERENCE TO RELATED APPLICATION

This application claims the benefit of U.S. application Ser. No. 17/733,732, filed Apr. 29, 2022, and U.S. Provisional Application No. 63/253,456, filed Oct. 7, 2021, each of which is incorporated herein by reference in its entirety.

### FIELD

This application relates generally to plant-based cheese products.

### BACKGROUND

Some commercially available plant-based cheese products include a starch-based gel. These typical plant-based cheese products often do not exhibit functional characteristics expected of dairy-based cheeses, including melting and stretching at cooking temperatures. Rather, at cooking temperatures, the starch-based gels in these products generally do not soften enough to resemble the melting behavior of dairy cheese. At higher cooking temperatures, the starch-based gels in these products generally lose their structure so that the product resembles a sauce rather than a melted dairy cheese. Additionally, these typical plant-based cheese products often have a dull appearance rather than the shiny appearance typical of dairy-based processed cheese (hereinafter “conventional processed cheese”). These plant-based cheese products are not as well accepted by consumers who expect a cooking and eating experience that replicates dairy-based cheeses.

Further, some commercially available plant-based cheese products do not have a nutritional content, and particularly a protein content, that is comparable to the protein content of dairy-based cheeses. Processed cheeses typically include from 13 wt % to 20 wt % crude protein, and dairy-based natural cheeses may include from 15 wt % to 40 wt % crude protein. As example, semi-hard dairy-based natural cheeses, such as natural cheddars, may include from 20 wt % to 30 wt % crude protein, hard dairy-based natural cheeses, such as natural parmesans, may include from 35 wt % to 40 wt % crude protein, and semi-soft dairy-based natural cheeses, such as natural fetas and natural mozzarellas, may include about 15 wt % crude protein. Commercially available plant-based cheese products typically include less than 2 wt % crude protein. Including higher amounts of protein can present significant manufacturing challenges, as well as adversely impact flavor, textural, and structural properties at different temperatures. These plant-based cheese products are not as well accepted by consumers who expect a nutritional content that is similar to dairy-based cheeses.

### BRIEF DESCRIPTION OF THE DRAWINGS

FIG. 1 and FIG. 2 are graphs of melting curves produced from rheometer temperature sweeps of commercial dairy-based cheeses and example plant-based cheese products illustrating the storage modulus (G′) and loss modulus (G″) of the samples (Pa, Y axis) over temperature (° C., X axis);

FIG. 3 is a graph of melting curves produced from rheometer temperature sweeps of commercial plant-based cheeses illustrating the storage modulus (G′) and loss modulus (G″) of the samples (Pa, Y axis) over temperature (° C., X axis);

FIG. 4 through FIG. 8 are graphs of melting curves produced from rheometer temperature sweeps of commercial plant-based cheeses and example plant-based cheese products illustrating the storage modulus (G′) and loss modulus (G″) of the samples (Pa, Y axis) over temperature (° C., X axis);

FIG. 9 is a graph of melting curves produced from rheometer temperature sweeps of a commercial dairy-based cheese, commercial plant-based cheeses, and example plant-based cheese products illustrating Tan δ of the samples (Y axis) over temperature (° C., X axis);

FIG. 10 and FIG. 11 are bar graphs illustrating the Tan δ at 80° C. of commercial dairy-based cheeses and example plant-based cheese products;

FIG. 12 and FIG. 13 are bar graphs illustrating the Tan δ at 80° C. of commercial dairy-based cheeses, commercial plant-based cheeses, and example plant-based cheese products;

FIG. 14 and FIG. 15 are bar graphs illustrating the stretch (mm) of commercial dairy-based cheeses and example plant-based cheese products;

FIG. 16 and FIG. 17 are bar graphs illustrating the stretch (mm) of commercial dairy-based cheeses, commercial plant-based cheeses, and example plant-based cheese products;

FIG. 18A through FIG. 18C are light microscopy images, with a 100 μm scale bar, of an example plant-based cheese product;

FIGS. 19A through 19E are images taken under polarized light to show degree of gelatinization in an example plant-based cheese product;

FIG. 20A through FIG. 20C are photographs of example plant-based cheese products before heating (FIG. 20A), after heating (FIG. 20B), and after 30 minutes of cooling (FIG. 20C); and

FIG. 21 and FIG. 22 are photographs of example plant-based cheese products.

Elements in the figures are illustrated for simplicity and clarity and have not necessarily been drawn to scale. For example, the dimensions and/or relative positioning of some of the elements in the figures may be exaggerated relative to other elements to help to improve understanding of various aspects of the present invention. Also, common but well-understood elements that are useful or necessary in a commercially feasible aspect are often not depicted in order to facilitate a less obstructed view of these various aspects of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Described herein are plant-based cheese products. The plant-based cheese products have a protein content that is comparable to the protein content in dairy-based cheeses. Further, it has been unexpectedly found that a plant-based cheese product with characteristics consistent with consumer expectations for a dairy-based cheese, such as melting and stretching at cooking temperatures, can be obtained through use of a combination of a plant-based protein in an amount of about 10 wt % to about 25 wt % crude protein, a waxy starch including at least 65 wt % amylopectin (or at least 70 wt % amylopectin), and a fat. As used herein, the term “plant-based” refers to a product or ingredient that is free of animal-based proteins, such as dairy proteins, and comprises a plant-derived protein.

In one approach, the plant-based cheese product includes: a plant-based protein present in an amount within the range of about 10 wt % to about 25 wt % crude protein, based on the total weight of the plant-based cheese product; a waxy starch comprising at least 65 wt % amylopectin (or at least 70 wt % amylopectin), based on a total weight of the waxy starch, wherein the waxy starch is at least partially gelatinized; and a fat.

The inclusion of a combination of plant-based protein, fat, and waxy starch has surprisingly been found to provide significant benefits to the performance of plant-based cheese products, including desirable melt and stretch characteristics at cooking temperatures. Additionally, when a plant-based cheese products is prepared with a plant-based protein in combination with a waxy starch and fat as described herein, the product exhibit improved mouthfeel as compared to plant-based cheese products prepared without a plant-based protein.

The protein content of the plant-based cheese products described herein is also beneficial from a nutritional standpoint. Conventional plant-based cheese products often have low protein content and consumers may be deem them to be nutritionally inferior to dairy-based cheeses.

The inclusion of the plant-based protein is also associated with desirable melt characteristics in the plant-based cheese. It is presently believed that the plant-based protein stabilizes the product matrix and maintains smaller droplets of the fat by coating the surface of the fat droplets. For example, plant-based cheese products prepared without a plant-based protein may appear similar to dairy-based cheese products at refrigeration temperature (e.g., 1° C. to 5° C.) but exhibit oil separation when subjected to cooking temperatures (e.g., 175° C. to 235° C.). This is believed to be due to the larger fat droplets. At refrigeration temperature, the fat may be solid, giving the product a cold texture similar to dairy-based cheese products. However, at cooking temperatures, the fat melts and without the plant-based protein to act as a stabilizer, coalesces into larger fat droplets, which easily separate from the rest of the product.

It has been found herein that small fat droplet size and emulsion stability is associated with good melt properties, meaning that the cheese product softens and spreads upon heating without significant oil separation. In one approach, the degree of melt can be measured by the increase in diameter of the plant-based cheese upon application of heat. The degree of melt can also be assessed in terms of the “Tan δ value,” which refers to the quotient of the loss modulus (G″) and the elastic modulus (G′) (i.e., G″/G′) of a melting profile of a sample measured in accordance with the method described in the Examples.

Further, inclusion of the plant-based protein has also been found to be associated with desirable stretch characteristics in the plant-based cheese products. Stretchability is measurable in terms of the distance a sample extends before breaking when subjected to an axial pull. In some aspects, a portion of the plant-based protein is solubilized and a portion of the plant-based protein is insoluble in the plant-based cheese product. The insoluble portion acts to coat the fat droplets, and the soluble portion, along with the at least partially gelatinized waxy starch, acts to form a network in the product. This network enables the plant-based cheese product to have stretch characteristics similar to a dairy-based cheese.

Inclusion of the waxy starch, and the gelatinization of the waxy starch during the cheesemaking process, is associated with stretch and hardness characteristics in the plant-based cheese product. Higher degrees of gelatinization have been found to be associated with higher hardness values and stretch in the resulting plant-based cheese products. The gelatinized starch is able to be incorporated with the protein to form a network, and the network is believed to provide stretch characteristics. To achieve the higher degrees of gelatinization, the starch must be sufficiently hydrated during the cheesemaking process. The method used to make the plant-based cheese should allow for sufficient hydration of the waxy starch to enable the intended degree of gelatinization to be achieved.

The plant-based cheese product includes a plant-based protein. Any suitable plant-based protein may be used in the plant-based cheese product. In some aspects, the plant-based protein comprises one or more of faba protein (also referred to as faba bean protein, fava bean protein, and fava protein), chickpea protein, mungbean protein, soy protein, zein protein, lupin protein, canola protein, pea protein (e.g., yellow pea protein), lentil protein, and flax protein. In one aspect, the plant-based protein comprises faba protein. In another aspect, the plant-based protein comprises Faba Bean Protein 90-C (FFBP-90-C) from AGT Food & Ingredients. FFBP-90-C is a faba bean protein isolate with 10.0% or less moisture (based on the total weight) and 89.0% or more crude protein, 2.0% or more starch, 2.0% or more dietary fiber, and 6.5% or more fat (based on the total dry weight). Protein functionality, including emulsion stability performance, may differ due to deviations in hydrophilic or hydrophobic properties, which may be a result of the type of protein and/or production method of the protein ingredient.

In some approaches, the plant-based protein can be in the form of an isolate, a concentrate, or a flour, though the precise form of the plant-based protein is not believed to be particularly limited. Generally, protein isolates have a higher crude protein content than protein concentrates. In one aspect, the plant-based protein may be in the form of an isolate. When the plant-based protein is in the form of an isolate, a higher wt % (e.g., about 10 wt % to about 25 wt %) of crude protein may be achieved in the plant-based cheese product for a given amount by weight of the isolate versus a concentrate, as well as minimize any deleterious effects (e.g., off flavors) due to any non-protein components of the protein isolate. In some approaches, the plant-based protein is in the form of an isolate or a concentrate that contributes to emulsification of the plant-based cheese product.

In some aspects, the plant-based protein is the only source of protein in the plant-based cheese product. In this respect, in some aspects, the plant-based cheese product includes no animal proteins, including, for example, casein and whey.

In some aspects, the plant-based cheese product includes no nut-based proteins, including, for example, one or more of almond protein, peanut protein, and cashew protein. Additionally, or alternatively, the plant-based cheese product may be free of one or more of oat protein, rice protein, wheat protein, and/or sunflower seeds.

In one approach, the plant-based protein is present in an amount within the range of about 10 wt % to about 25 wt % crude protein, based on the total weight of the plant-based cheese product. In another approach, the plant-based protein is present in an amount within the range of about 12 wt % to about 25 wt %, about 14 wt % to about 25 wt %, about 15 wt % to about 25 wt %, about 16 wt % to about 25 wt %, about 18 wt % to about 25 wt %, about 20 wt % to about 25 wt %, about 10 wt % to about 23 wt %, about 12 wt % to about 23 wt %, about 14 wt % to about 23 wt %, about 15 wt % to about 23 wt %, about 16 wt % to about 23 wt %, about 18 wt % to about 23 wt %, about 20 wt % to about 23 wt %, about 10 wt % to about 20 wt %, 12 wt % to about 20 wt %, about 14 wt % to about 20 wt %, about 15 wt % to about 20 wt %, about 16 wt % to about 20 wt %, about 18 wt % to about 20 wt %, about 10 wt % to about 18 wt %, 12 wt % to about 18 wt %, about 14 wt % to about 18 wt %, about 15 wt % to about 18 wt %, or about 16 wt % to about 18 wt % crude protein based on the total weight of the plant-based cheese product.

The amount of crude protein in a plant-based protein ingredient may depend on the form of the ingredient (e.g., whether the ingredient is in the form of an isolate, a concentrate, or a flour). Therefore, for purposes herein, the amount of crude protein content is the amount of protein contributed by any protein-containing ingredient. For instance, the faba protein isolate product commercially available from AGT Food & Ingredients (Canada) includes about 90% protein and about 10% non-protein components. If a plant-based cheese product includes about 18 wt % faba protein isolate product (AGT Food & Ingredients), the plant-based cheese product will include about 16 wt % plant-based protein, for percentage purposes herein. As another example, the commercially available ARTESA® chickpea protein product includes about 60% protein and about 40% non-protein components. For instance, if a plant-based cheese product includes about 13 wt % ARTESA® chickpea protein product, the plant-based cheese product will include about 8 wt % plant-based protein, for percentage purposes herein. The amount of crude protein in a plant-based protein ingredient or in the plant-based cheese product may be measured by the Association of Official Analytical Chemists (AOAC) Official Method 992.15 (which is incorporated herein by reference in its entirety). Additionally, or alternatively, the amount of crude protein in a plant-based protein ingredient or in the plant-based cheese product may be measured by the Dumas Method.

The plant-based protein may be the only emulsifier in the plant-based cheese product. In some aspects, the plant-based cheese product is free from lecithin, monoglycerides, diglycerides, polyethylene glycol, propylene glycol alginate, and polysorbate. In other approaches, the plant-based cheese product may also be free of any one or more of glucono-Delta-Lactone, tricalcium phosphate, sugar, beta Carotene (color), and sodium citrate. In other aspects, the plant-based cheese product includes 3 wt % or less of lecithin, monoglycerides, diglycerides, polyethylene glycol, propylene glycol alginate, and polysorbate. In other aspects, the plant-based cheese product includes 1.5 wt % or less of monoglycerides, diglycerides, polyethylene glycol, propylene glycol alginate, and polysorbate. In some approaches, about 0.1 wt % to about 3 wt % of lecithin or about 0.2 wt % to about 1.5 wt % of one or more of a monoglyceride and a diglyceride may be included in the plant-based cheese product to reduce surface tension at the oil-water interface.

As used herein, the term “emulsifier” does not include phosphates or citrates. In some approaches, about 2 wt % to about 5 wt % of one or more phosphates and citrates may be included in the plant-based cheese product. The phosphates and/or citrates may be used to change the protein structure to alter its functionality.

The plant-based cheese products further include a waxy starch. Any suitable waxy starch may be used in the plant-based cheese product. In some examples, the waxy starch comprises one or more of a native waxy maize, a tapioca starch, and a casava starch. In some aspects, the waxy starch comprises native waxy maize. Additionally, or alternatively, the waxy starch comprises one or more of a tapioca starch and a casava starch. Additionally, or alternatively, the waxy starch comprises octenyl succinic anhydride (OSA) potato starch.

The waxy starch includes at least 65 wt % amylopectin, based on the total weight of the waxy starch. In some approaches, waxy starch includes at least 70 wt %, at least 80 wt %, or at least 90 wt % amylopectin, based on the total weight of the waxy starch.

The waxy starch is at least partially gelatinized in the plant-based cheese product. If added in ungelatinized or native form, the waxy starch needs to be at least partially gelatinized during the cheesemaking process. If a pregelatinized starch is used, plant-based cheese product may have a lower hardness than if the starch is added in ungelatinized or native form and at least partially gelatinized during the cheesemaking process. The structuring effect of the starch may be lost during the mixing process when a pregelatinized starch is used. As such, it may be undesirable to use a pregelatinized starch. Accordingly, in one aspect, the plant-based cheese product does not include a pregelatinized starch. As used herein, “partial gelatinization” or similar term means that the starch has begun to swell and lose some of the crystalline structure. The at least partially gelatinized starch contributes to the plant-based cheese product exhibiting functional characteristics expected of dairy-based cheeses. For example, the at least partially gelatinized starch, in combination with the protein and fat content, may enable the plant-based cheese product to have a structure and/or functionality similar to dairy-based cheese products at refrigerated and room temperatures, while melting and stretching at cooking temperatures.

Generally, the level of gelatinization of the starch can be adjusted based on desired properties in the final plant-based cheese product, as described in further detail below. The degree of gelatinization can be any suitable amount, such as about 20% or more, about 25% or more, about 30% or more, about 35% or more, about 40% or more, about 45% or more, about 50% or more, about 55% or more, about 60% or more, about 65% or more, about 70% or more, about 75% or more, about 80% or more, about 85% or more, about 90% or more, and about 95% or more. In general, the starch need not be fully gelatinized to provide desirable melting and stretching properties to the plant-based cheese product. However, low degrees of gelatinization will more closely approximate granular (native) starch and may not exhibit the stretch and melting properties achievable with higher degrees of starch gelatinization. The level of starch gelatinization may be measured, for instance, by differential scanning calorimetry (DSC), optical microscopy, X-ray diffraction, or other suitable technique. By one approach, optical microscopy with polarized light may be used to assess the birefringent Maltese crosses present in the sample. A sample that has undergone a heat treatment in a cheesemaking process can be compared to an otherwise identical sample (i.e., includes the same ingredients in the same amounts) that has not undergone a heat treatment step. A decrease in the number of Maltese crosses is associated with higher degrees of gelatinization. The relative differences in the number of Maltese crosses will demonstrate the extent of gelatinization that has taken place during the cheesemaking process. The degree of gelatinization may be similarly visualized by using a stain for starch and evaluating by light microscopy whether the starch is in the form of fragments formed from ruptured granules.

In one approach, the waxy starch is present in an amount within the range of about 5 wt % to about 20 wt %, based on the total weight of the plant-based cheese product. In another approach, the waxy starch is present in an amount within the range of about 10 wt % to about 20 wt %, about 5 wt % to about 16 wt %, about 10 wt % to about 16 wt %, or about 12 wt % to about 16 wt %, based on the total weight of the plant-based cheese product.

The plant-based cheese product further includes water. In some aspects, the plant-based cheese product includes water in an amount effective to provide a moisture % of the plant-based cheese product within the range of about 35 wt % to about 80 wt %, about 40 wt % to about 80 wt %, about 45 wt % to about 80 wt %, about 35 wt % to about 75 wt %, about 40 wt % to about 75 wt %, about 45 wt % to about 75 wt %, about 35 wt % to about 70 wt %, about 40 wt % to about 70 wt %, about 45 wt % to about 70 wt %, about 50 wt % to about 80 wt %, in another aspect about 50 wt % to about 75 wt %, in another aspect about 55 wt % to about 75 wt %, in another aspect about 55 wt % to about 70 wt %, or in another aspect about 60 wt % to about 70 wt %, by weight of the plant-based cheese product.

The plant-based cheese product further includes a fat. Any suitable fat may be used in the plant-based cheese product. In some aspects, fat comprises one or more of coconut oil, shea oil, shea stearin, shea olein, shea butter, palm oil, palm oil fraction, sunflower oil, cocoa butter, and cottonseed glycerolysis. In one aspect, the fat comprises coconut oil. In another aspect, the fat comprises coconut oil and sunflower oil.

In some approaches, the fat is in the form of one or more solid fats or a combination of one or more solid fats and one or more liquid oils. As used herein, solid fats refer to fats that are solid at room temperature (20° C.), and liquid oils refer to fats that are in liquid form at room temperature (20° C.). In some examples, the fat has a solid fat content in the range of about 32% to about 95% at 10° C. (based on the total weight of the fat). In other examples, the fat has a solid fat content in the range of about 70% to about 85% at 10° C. (based on the total weight of the fat). Additionally, or alternatively, the fat has a solid fat content in the range of about 28% to about 80%, in another aspect about 32% to about 55%, at 20° C. (based on the total weight of the fat). Additionally, or alternatively, the fat has a solid fat content in the range of 0% to about 20%, in another aspect about 0% to about 15%, at 30° C. (based on the total weight of the fat). Additionally, or alternatively, the fat has a solid fat content in the range of 0% to about 5% or 0% to 4% at 40° C. (based on the total weight of the fat).

In some examples, the fat has a solid fat content in the range of about 32% to about 95% at 10° C., about 28% to about 80% at 20° C., 0% to about 20% at 30° C., and 0% to about 5% at 40° C. (based on the total weight of the fat). In some examples, the fat has a solid fat content in the range of about 70% to about 85% at 10° C., about 32% to about 55% at 20° C., 0% to about 15% at 30° C., and 0% to less than 5% at 40° C. (based on the total weight of the fat).

Selecting one or more fats to provide the described solid fat contents at 10° C., 20° C., 30° C., and/or 40° C. provides the plant-based cheese products with a solid texture at refrigeration temperatures but also softens at a temperature at which a heated plant-based cheese product may be consumed (i.e., about 60° C.).

In one approach, the fat is present in an amount within the range of about 15 wt % to about 30 wt %, based on the total weight of the plant-based cheese product. In other approaches, the fat is present in an amount within the range of about 19 wt % to about 27 wt %, about 19 wt % to about 25 wt %, about 20 wt % to about 27 wt %, or about 20 wt % to about 25 wt %, based on the total weight of the plant-based cheese product. As noted above, the fat may comprise one or more solid fats or liquid fat components.

The solid fat contents of exemplary fat components that may be used in the plant-based cheese products are shown below in Table 1. The fat components may be used alone or in combination, as needed, to provide a desired solid fat content at 10° C., 20° C., 30° C., and/or 40° C.

TABLE 1
(Solid Fat Content (%))

| | 10° C. | 20° C. | 30° C. | 40° C. |
|---|---|---|---|---|
| Coconut Oil | 78.1 | 34.6 | 0.3 | 0.9 |
| Shea Oil | 0 | 0 | 0 | 0 |
| Shea Stearin | 80 | 65 | 12 | 2 |
| Shea Olein | 68 | 30 | 2 | 0.5 |
| Shea Butter | 68 | 37 | 28 | 1.6 |
| Palm Oil | 47.9 | 27 | 9.4 | 0.7 |
| Sunflower Oil | 0 | 0 | 0 | 0 |
| Cocoa Butter | 94.8 | 78.6 | 8.49 | 0 |
| Cottonseed Glycerolysis | 28 | 22 | 16 | 12 |
| 50% Coconut Oil and | 79.1 | 49.8 | 6.2 | 1.5 |
| 50% Shea Stearin | | | | |

In some approaches, the fat is in the form of an oleogel. An oleogel is a semi-solid system where the continuous phase is liquid oil. To prepare an oleogel, an additional component, the oleogelator (also referred to as the organogelator), is added to a fat to form the oleogel. In some examples, forming the oleogel includes heating the fat to provide a liquid fat and the oleogelator to dissolve the oleogelator in the fat. Exemplary oleogelators include ethyl cellulose, wax, phytosterol, bentonite clay, soy lecithin, mucilage, and fenugreek gum. Oleogels are generally characterized as having physical properties more typical of fat components having a higher solid fat content. In the oleogel, the liquid oil is entrapped by the oleogelator, which acts as a structuring agent. Advantageously, the oleogels may provide the functionality of solid fats to the resulting food product but with the nutritional profile of liquid oils.

In some aspects, the oleogelator is a wax. As such, in some aspects, the plant-based cheese product further includes a wax having a melting point less than 80° C. In some aspects, the plant-based cheese product further includes a wax having a melting point less than 70° C. or less than 60° C. Any suitable wax may be used in the plant-based cheese product. In some aspects, wax comprises one or more of orange wax, rice bran wax, sunflower wax, beeswax (e.g., white beeswax or yellow beeswax), propolis wax, and candelilla wax. In other aspects, the wax comprises one or more of beeswax and candelilla wax. In other aspects, the wax comprises one or more of orange wax, rice bran wax, sunflower wax, and white beeswax. In other aspects, the wax comprises one or more of orange wax, rice bran wax, and sunflower wax. In one aspect, the wax comprises candelilla wax.

In some approaches, the combination of the fat and the wax has a crystallization temperature below 60° C. In other approaches, the combination of the fat and the wax has a crystallization temperature within the range of 5° C. to 60° C. In these approaches, the plant-based cheese product resembles a non-melted dairy-based cheese below the crystallization temperature and a melted dairy-based cheese above the crystallization temperature.

In some aspects, the plant-based cheese product includes no animal products, such as beeswax.

In one approach, the wax is present in an amount within the range of about 0.1 wt % to about 5 wt %, based on the total weight of the fat. In another approach, the wax is present in an amount within the range of about 0.5 wt % to about 5 wt %, about 0.5 wt % to about 3 wt %, about 0.5 wt % to about 2.5 wt %, about 0.5 wt % to about 2 wt %, or about 1 wt % to about 2 wt %, based on the total weight of the fat. In one particular aspect, the wax used in an amount of about 1 wt % to about 2 wt % is white bees wax and/or orange wax, which have been found to provide additional stretching properties to the resulting plant-based cheese products. In another particular aspect, sunflower wax is used in an amount of about 1.5 wt % to about 2.5 wt %, which has been found to provide increased melting properties to the resulting plant-based cheese products.

If too low of an amount of wax is used, the wax may not provide enough structuring effect to the fat. If too high of an amount of wax is used, the wax may impart undesirable sensory characteristics (e.g., mouthfeel) to the plant-based cheese product.

In some aspects, the plant-based cheese product further includes a non-wax oleogelator, such as ethyl cellulose, phytosterol, bentonite clay, soy lecithin, mucilage, or fenugreek gum, to form an oleogel. Examples of ethyl cellulose include 45 cp ETHOCEL™ Standard 45 (The Dow Chemical Company, Michigan, USA) and 20 cp ETHOCEL™ Standard 20 (The Dow Chemical Company, Michigan, USA).

In one approach, the oleogelator is present in an amount within the range of about 0.1 wt % to about 5 wt %, based on the total weight of the fat. In another approach, the oleogelator (e.g., ethyl cellulose) is present in an amount within the range of about 0.1 wt % to about 3 wt %, about 0.1 wt % to about 2 wt %, or about 0.5 wt % to about 1.5 wt %, based on the total weight of the fat.

In some approaches, including the wax and/or the ethyl cellulose, has surprisingly been found to significantly reduce the oil loss (i.e., the separation of oil from the other ingredients) of the plant-based cheese product when the plant-based cheese product is heated. In some approaches, including the wax and/or the ethyl cellulose, has surprisingly been found to increase the melt percentage and/or the evenness of the melt of the plant-based cheese product when the plant-based cheese product is heated.

The plant-based cheese product may also include exopolysaccharide (EPS). In some aspects, the plant-based cheese product further includes EPS when the plant-based cheese product includes the waxy starch in an amount within the range of about 5 wt % to about 10 wt %. In one approach, the EPS may be produced by L. lactis strain 329, deposited as ATCC PTA-120552 and described in U.S. Pub. No. 2020/0068914 which is incorporated herein by reference. Additionally, or alternatively, the EPS may be added to the plant-based cheese product in an aqueous mixture or water. The EPS may be included in the plant-based cheese product in an amount (by dry weight of the EPS) greater than 0 wt % to about 0.5 wt %, based on the total weight of the plant-based cheese product.

In some examples, the plant-based cheese product further includes an acidulant in an amount effective to provide a pH of the plant-based cheese product of about 4.5 to about 5.5. In other examples, the plant-based cheese product further includes an acidulant in an amount effective to provide a pH of the plant-based cheese product of about 4.8 to about 5.5, and in another aspect about 4.8 to about 5.0. Any suitable acidulant may be used. In one example, the acidulant comprises one or more of citric acid, malic acid, acetic acid, phosphoric acid, sorbic acid, and lactic acid. In some approaches, the lactic acid is not produced via fermentation in a dairy-based media.

In some aspects, the plant-based cheese product may further include additional components. Examples of additional components that may be included in the plant-based cheese product include one or more of a salt, an antimicrobial agent, flavoring agents, and colors.

In some aspects, the plant-based cheese product may be free from one or more of nut-based proteins, almond protein, peanut protein, cashew protein, oat protein, rice protein, wheat protein, sunflower seeds, non-plant-based protein emulsifiers, lecithin, monoglycerides, diglycerides, polyethylene glycol, propylene glycol alginate, polysorbate, palm oil, and palm oil fraction.

Also disclosed herein is a method of making the plant-based cheese product. In one approach, the method includes: dissolving a first amount of a plant-based protein in an aqueous liquid (e.g., water) to form an aqueous plant-based protein mixture (e.g., in the form of a solution and/or suspension); heating a fat to form a melted fat; emulsifying the plant-based protein solution or suspension with the melted fat to form an emulsion; adding a second amount of the plant-based protein and a waxy starch to the emulsion and mixing to form a mixture; heating and mixing the mixture for a time effective to at least partially gelatinize the waxy starch to form a heated mixture; and cooling the heated mixture to form the plant-based cheese product; wherein the plant-based cheese product comprises about 10 wt % to about 25 wt % crude protein, based on a total weight of the plant-based cheese product; and wherein the waxy starch comprises at least 65 wt % amylopectin (or at least 70 wt. % amylopectin), based on a total weight of the waxy starch.

The method includes adding a first amount of a plant-based protein in an aqueous liquid (e.g., water) to form an aqueous plant-based protein mixture (e.g., in the form of a solution and/or suspension. The first amount of plant-based protein is less than the total amount of protein included in the final product. At least in some approaches, it has been found to be beneficial to mix a first amount of the plant-based protein in an aqueous liquid while limiting the addition of other dry ingredients, such as the waxy starch and second amount of the protein, until a later step. Addition of all dry ingredients at once can adversely impact the hydration of the ingredients and their functionality in the product.

In the initial aqueous plant-based protein mixture, whether a protein solution or suspension is formed may depend, at least in part, on the solubility of the plant-based protein. In one approach, at least a portion of the plant-based protein dissolves in the aqueous liquid and at least a portion of the plant-based protein is suspended in the aqueous liquid. It is presently believed that when at least a portion of the plant-based protein dissolves in the aqueous liquid and at least a portion of the plant-based protein is suspended or dispersed in the aqueous liquid, the dispersed plant-based protein coats the fat droplets and the dissolved plant-based protein, along with the waxy starch, forms a network. In some aspects, the aqueous plant-based mixture includes from about 2% w/v to about 8% w/v of the plant-based protein. In other aspects, the aqueous plant-based protein mixture includes from about 4% w/v to about 6% w/v of the plant-based protein. The first amount of the plant-based protein may be selected to achieve the desired % w/v of the plant-based protein in the aqueous plant-based protein mixture.

In one approach, the first amount of the plant-based protein is about 10 wt % to about 60 wt %, based on the total weight of the plant-based protein in the plant-based cheese product. In another approach, the plant-based protein is about 15 wt % to about 60 wt %, about 15 wt % to about 50 wt %, about 15 wt % to about 40 wt %, about 15 wt % to about 35 wt %, about 15 wt % to about 33 wt %, about 15 wt % to about 30 wt %, about 15 wt % to about 25 wt %, about 15 wt % to about 20 wt %, about 20 wt % to about 50 wt %, about 20 wt % to about 40 wt %, about 20 wt % to about 35 wt %, about 20 wt % to about 33 wt %, about 20 wt % to about 30 wt %, about 20 wt % to about 25 wt %, about 25 wt % to about 50 wt %, about 25 wt % to about 40 wt %, about 25 wt % to about 35 wt %, about 25 wt % to about 33 wt %, about 25 wt % to about 30 wt %, about 30 wt % to about 50 wt %, about 30 wt % to about 40 wt %, about 30 wt % to about 35 wt %, about 30 wt % to about 33 wt %, about 33 wt % to about 50 wt %, about 33 wt % to about 40 wt %, about 33 wt % to about 35 wt %, about 35 wt % to about 50 wt %, about 35 wt % to about 40 wt %, or about 40 wt % to about 50 wt %, based on the total weight of the plant-based protein in the plant-based cheese product.

The method further includes heating a fat to form a melted fat. In some examples, the heating of the fat is to a temperature within the range of about 35° C. to about 60° C.

In some approaches, the method further includes adding an oleogelator to the fat to form an oleogel. In some of these approaches, the oleogelator is added to the fat before the fat is heated to form the melted fat. In others of these approaches, the oleogelator is added to the fat while the fat is heated to form the melted fat. In some aspects, adding the oleogelator after the fat is heated to form the melted fat may help incorporate the oleogelator into the fat. In some examples, the oleogelator includes one or more of ethyl cellulose, wax, phytosterols, bentonite clay, soy lecithin, mucilage, and fenugreek. In some examples, the method further includes heating the combination of the fat and the oleogelator to dissolve the oleogelator (e.g., a temperature within the range of about 60° C. to about 140° C.). In some approaches, the aqueous plant-based protein mixture is heated to a temperature that is similar to the temperature of the combination of the fat and the oleogelator before emulsifying the aqueous plant-based protein mixture with the melted fat and oleogelator. The temperature of the aqueous plant-based protein mixture should be sufficiently close to the temperature of the combination of the fat and oleogelator such that the mixing of the protein mixture with the fat and oleogelator doesn't cause crystallization of the fat. For instance, the aqueous plant-based protein mixture may have a temperature that is ±20° C., in another aspect ±10° C., in another aspect ±5° C., in another aspect ±2° C., of the temperature of the combined fat and oleogelator when mixed with the plant-based protein mixture.

In some examples, the method further includes adding a wax having a melting point less than 80° C. to the fat. In some of these examples, the wax is added to the fat before the fat is heated to form the melted fat. In others of these examples, the wax is added to the fat while the fat is heated to form the melted fat. In others of these examples, the wax is added to the fat after the fat is heated to form the melted fat. In some aspects, adding the wax after the fat is heated to form the melted fat may help incorporate the wax into the fat. In some examples, the wax includes one or more of orange wax, rice bran wax, sunflower wax, beeswax, propolis wax, and candelilla wax. In some examples, the wax includes candelilla wax. In some examples, the method further includes heating the combination of the fat and wax to dissolve the wax (e.g., a temperature within the range of about 60° C. to about 80° C.). In some approaches, the aqueous plant-based protein mixture is heated to a temperature that is similar to the temperature of the combination of the fat and the wax before emulsifying the aqueous plant-based protein mixture with the melted fat. The temperature of the aqueous plant-based protein mixture should be sufficiently close to the temperature of the combination of the fat and wax such that the mixing of the protein mixture with the fat and wax doesn't cause crystallization of the fat (and/or the wax). For instance, the aqueous plant-based protein mixture may have a temperature that is ±10° C., in another aspect ±5° C., in another aspect ±2° C., of the temperature of the combined fat and wax when mixed therewith.

In some approaches, the method further includes adding ethyl cellulose to the fat to form an oleogel. In some of these approaches, the ethyl cellulose is added to the fat before the fat is heated to form the melted fat. In others of these approaches, the ethyl cellulose is added to the fat while the fat is heated to form the melted fat. In others of these examples, the ethyl cellulose is added to the fat after the fat is heated to form the melted fat. In some aspects, adding ethyl cellulose after the fat is heated to form the melted fat may help incorporate the ethyl cellulose into the fat. In some examples, the method further includes heating the combination of the fat and the ethyl cellulose to dissolve the ethyl cellulose (e.g., a temperature within the range of about 130° C. to about 140° C.). The temperature of the aqueous plant-based protein mixture should be sufficiently close to the temperature of the combination of the fat and ethyl cellulose such that the mixing of the protein mixture with the fat and ethyl cellulose doesn't cause crystallization of the fat. For instance, the aqueous plant-based protein mixture may have a temperature that is ±20° C., in another aspect ±10° C., in another aspect ±5° C., in another aspect ±2° C., of the temperature of the combined fat and ethyl cellulose when mixed therewith.

The method also includes emulsifying the aqueous plant-based protein mixture with the melted fat to form an emulsion. This step with the first amount of protein may be characterized as a pre-emulsion step. In some approaches, the emulsion is a homogenous mixture or a substantially homogenous mixture. In some approaches, the emulsion is uniform in color and/or has no visible oil separation. It is not presently believed that a particular oil droplet size needs to be achieved to provide a suitable emulsion. Rather, it is believed that the plant-based protein coating the oil droplets is what provides a suitable stable emulsion. However, it is possible to overwork an emulsion, which may lead to an unstable emulsion and oiling off. Therefore, care should be taken that the emulsification step be long enough to achieve a desired oil droplet size or homogenous mixture while not being so long as to overwork the emulsion and reduce the emulsifying functionality of the protein.

Fat droplet size and emulsion stability impact overall performance of the plant-based cheese product, including melt performance. In some aspects, the plant-based cheese product has a fat droplet size distribution that enables the plant-based cheese product to have melt and stretch characteristics similar to a dairy-based cheese at elevated temperatures, such as cooking temperatures (e.g., 35° C. to 75° C.). The fat droplet size distribution may be measured using a Bruker time-domain nuclear magnetic resonance droplet size analyzer (Bruker TD-NMR droplet size analyzer). A decay curve (intensity vs. time) of the NMR field may be used to derive the fat droplet size distributions.

It has been found that large fat droplets (e.g., 20-60 μm) may result in oil pooling and/or oiling off in the final product. Further, it has been found in conventional dairy products that small fat droplets (e.g., around 0.2-2 μm in homogenized milk) result in better mouthfeel. Accordingly, in the present plant-based cheese products, it is also desirable to select a protein ingredient that is effective to achieve good emulsion stability, meaning that the protein should cover the fat droplet surface and assist in maintaining the fat droplet size in a range of about 0.2 μm to about 20 μm at cooking temperatures (e.g., 35° C. to 75° C.).

In one aspect, the mixture may be emulsified to achieve a D50 (i.e., 50% of the fat droplets diameters are below this value) at 20° C. within the range of greater than 0 μm to about 20 μm, in another aspect within the range of 0.2 μm to about 20 μm, in another aspect within the range of greater than 0 μm to about 15 μm, in another aspect within the range of 0.2 μm to about 15 μm, in another aspect within the range of greater than 0 μm to about 10 μm, in another aspect within the range of 0.2 μm to about 10 μm, within the range of greater than 0 μm to about 7 μm, in another aspect within the range of 0.2 μm to about 7 μm, in another aspect within the range of greater than 0 μm to about 5 μm, in another aspect within the range of 0.2 μm to about 5μm, in another aspect within the range of greater than 0 μm to about 3 μm, in another aspect within the range of 0.2 μm to about 3 μm, in another aspect within the range of greater than 0 μm to about 2 μm, in another aspect within the range of about 0.2 μm to about 2 μm.

The method includes adding a second amount (at least in some approaches, the remaining amount) of the plant-based protein and a waxy starch to the emulsion and mixing to form a mixture. At least part of the second amount of the plant-based protein may dissolve in the mixture. Additionally, or alternatively, at least part of the second amount of the plant-based protein may be suspended in the mixture. Whether at least part of the second amount of the plant-based protein is dissolved and/or at least part of the second amount of the plant-based protein is suspended in the mixture may depend, at least in part, on the solubility of the plant-based protein. The second amount of the plant-based protein may be selected to achieve the desired crude protein amount in the final plant-based cheese product. The waxy starch includes at least 65 wt % amylopectin (or at least 70 wt. % amylopectin), based on a total weight of the waxy starch. In some examples, the waxy starch includes one or more of a native waxy maize, a tapioca starch, and a casava starch. In some examples, the waxy starch includes native waxy maize. In some examples, the waxy starch includes one or more of a tapioca starch and a casava starch.

In some approaches, the second amount of the plant-based protein and the waxy starch may be added in two or more batches with mixing between. In some examples, each batch may include at least a portion of the plant-based protein and at least a portion of the waxy starch.

It is presently believed that forming the aqueous plant-based protein mixture and emulsifying the first amount of aqueous plant-based protein mixture with the melted fat prior to adding the waxy starch allows the first amount of the plant-based protein to both form a network and also coat the fat droplets. Further, it is believed that this protein network enables the plant-based cheese product to have melt and stretch characteristics similar to a dairy-based cheese. If the waxy starch was added before the initial emulsion was formed, it is believed that the water would hydrate the waxy starch and the plant-based protein would be unable to dissolve and/or disperse throughout the water to both form a network and coat the fat droplets.

It is also presently believed that adding the waxy starch with the second amount of the plant-based protein allows the waxy starch to at least partially gelatinize and the second amount of the plant-based protein to be better incorporated into the mixture. The degree of gelatinization of the waxy starch contributes to the hardness and stretch characteristics of the product, with higher degrees of gelatinization associated with higher firmness values. If the second amount of the plant-based protein is added before the waxy starch, the waxy starch would be less hydrated and under gelatinized. If the waxy starch is under gelatinized, it is not incorporated into the protein network and the plant-based cheese product will have less stretch and be less like some dairy-based cheeses.

Further, if the waxy starch is added before the second amount of the plant-based protein, the second amount of the plant-based protein may be more difficult to incorporate into the mixture. If the second amount of the plant-based protein is unable to be incorporated, the plant-based cheese product may not have a protein content that is comparable to the protein content of dairy-based cheeses while also providing a desired smooth mouthfeel. The unincorporated protein would aggregate, resulting in graininess in the final product.

In some aspects, the method further includes adding an acidulant to the emulsion or the mixture. In some of these aspects, the acidulant is added in an amount effective to provide a pH within the range of about 4.5 to about 5.5 in the plant-based cheese product. In some of these aspects, the acidulant includes one or more of citric acid, malic acid, acetic acid, phosphoric acid, sorbic acid, and lactic acid.

In another aspect, the methods may further include adding one or more of salt, a preservative, colorant, and flavor.

The method further includes heating and mixing the mixture for a time and at a temperature effective to at least partially gelatinize the waxy starch and form a heated mixture. The heating and mixing the mixture may be continued until the desired characteristics of the plant-based cheese product are achieved. For example, the longer the mixture is heated and mixed (at a temperature above the starch gelatinization temperature), greater hardness of the plant-based cheese product may be achieved. Also, use of higher temperatures during the heating and mixing step may result in greater hardness of the plant-based cheese product. The increase in hardness of the plant-based cheese product as the mixture is heated and mixed, may be due, at least in part, to the increase in degree of starch gelatinization that occurs as the mixture is heated and mixed for longer periods of time and/or at higher temperatures.

The method also includes cooling the heated mixture to form the plant-based cheese product. In some approaches, the plant-based cheese product is cooled to refrigeration temperatures.

The method may further include filling the heated mixture into a container prior to the cooling step.

The plant-based cheese product disclosed herein may be formed into any desirable shape. In some examples, the plant-based cheese product is in the form of a cheese block, a sliced cheese, a diced cheese, or a shredded cheese.

The method described herein may also further include cutting the plant-based cheese product into various shapes and sizes, such as blocks, slices, cubes, shreds, and the like.

The methods described herein can be modified to provide a desired hardness of the plant-based cheese product. In this respect, the methods can be advantageously used to simulate the hardness characteristics typical of various types of dairy-based cheeses, including, for example, processed cheese, hard cheese, semi-soft, soft, and soft-ripened cheese, as defined by 21 C.F.R. § 133.102 to § 133.196.

In some aspects, the plant-based cheese product has a hardness consistent with consumer expectations for a conventional (dairy-based) processed cheese or a dairy-based semi-hard natural cheese (e.g., a dairy-based natural mild cheddar cheese). As used herein, the term “hardness” refers to the force of a sample (at 5° C.) measured when compressed by 50% in accordance with the method described below in the Examples (Texture Analysis).

In some examples, the plant-based cheese product has a hardness within the range of about 15 N to about 118 N, about 15 N to about 103 N, or about 15 N to about 90 N, when compressing the plant-based cheese product by 50% at 5° C. In other examples, the plant-based cheese product has a hardness within the range of about 15 N to about 25 N or about 70 N to about 95 N, when compressing the plant-based cheese product by 50%. Generally, hardness values in the range of to about 15 N to 103 N are similar to conventional dairy-based processed cheeses. Hardness values in the range of about 86 N to about 118 N are similar to conventional dairy-based natural cheeses.

In some approaches, the plant-based cheese product has a hardness within the range of about 19 N to about 21 N, when compressing the plant-based cheese product by 50%. In these approaches, the hardness of the plant-based cheese product may be considered to be consistent with consumer expectations for the hardness of a conventional (dairy-based) processed cheese. In some approaches, the plant-based cheese product has a hardness within the range of about 76 N to about 90 N, when compressing the plant-based cheese product by 50%. In these approaches, the hardness of the plant-based cheese product may be considered to be consistent with consumer expectations for the hardness of a dairy-based natural mild cheddar cheese. In other approaches, the plant-based cheese product has a hardness within the range of about 19 N to about 21 N or within the range of about 76 N to about 90 N, when compressing the plant-based cheese product by 50%.

In some aspects, the plant-based cheese product has a melt percentage consistent with consumer expectations for a conventional (dairy-based) processed cheese or a dairy-based semi-hard natural cheese (e.g., a dairy-based natural mild cheddar cheese). As used herein, the term “melt percentage” refers to percent increase in diameter of a sample measured when heated in accordance with the method described below in the Examples (Disk Melt Test (Modified Schreiber Test)).

In some approaches, the plant-based cheese product has a melt percentage within the range of about 65% to about 185%. In other approaches, the plant-based cheese product has a melt percentage within the range of about 80% to about 185%, about 98% to about 185%, about 110% to about 185%, about 65% to about 155%, 80% to about 155%, about 98% to about 155%, or about 110% to about 155%. In these approaches, the melt percentage of the plant-based cheese product may be considered to be consistent with consumer expectations for the melt percentage of a conventional (dairy-based) processed cheese and/or a dairy-based semi-hard natural cheese (e.g., a dairy-based natural mild cheddar cheese).

In some aspects, the plant-based cheese product has an oil loss consistent with consumer expectations for a conventional (dairy-based) processed cheese or a dairy-based semi-hard natural cheese (e.g., a dairy-based natural mild cheddar cheese). As used herein, the term “oil loss” refers to the oil loss score of a sample measured when heated in accordance with the method described below in the Examples (Oil Loss).

In some approaches, the plant-based cheese product has an oil loss of 6 or less. In these approaches, the oil loss of the plant-based cheese product may be considered to be consistent with consumer expectations for the oil loss of a dairy-based semi-hard natural cheese (e.g., a dairy-based natural mild cheddar cheese). In some approaches, the plant-based cheese product has an oil loss of 4 or less, 2 or less, or 1 or less. In some approaches, the plant-based cheese product has an oil loss of 0. In these approaches, the oil loss of the plant-based cheese product may be considered to be consistent with consumer expectations for the oil loss of a conventional (dairy-based) processed cheese.

In some aspects, the plant-based cheese product has a Tan δ value at 80° C. consistent with consumer expectations for a conventional (dairy-based) processed cheese or a dairy-based semi-hard natural cheese (e.g., a dairy-based natural mild cheddar cheese). As used herein, the term “Tan δ value” refers to the quotient of the loss modulus (G″) and the elastic modulus (G′) (i.e., G″/G′) of a melting profile of a sample measured in accordance with the method described below in the Examples (Rheometer Temperature Sweep).

In some approaches, the plant-based cheese product has a Tan δ value greater than 0.3 at 80° C. In other approaches, the plant-based cheese product has a Tan δ value greater than 0.4 at 80° C., greater than 0.6 at 80° C., greater than 0.8 at 80° C., greater than 1.0 at 80° C., greater than 1.2 at 80° C., or greater than 1.4 at 80° C. In these approaches, the Tan δ value at 80° C. of the plant-based cheese product may be considered to be consistent with consumer expectations for the Tan δ value at 80° C. of a conventional (dairy-based) processed cheese and/or a dairy-based semi-hard natural cheese (e.g., a dairy-based natural mild cheddar cheese). For example, Kraft® American Singles cheese slices have a Tan δ of about 1.5.

In some aspects, the plant-based cheese product has a stretch at 80° C. consistent with consumer expectations for a conventional (dairy-based) processed cheese or a dairy-based semi-hard natural cheese (e.g., a dairy-based natural mild cheddar cheese). As used herein, the term “stretch” refers to the distance a sample extends before breaking when subjected to an axial pull in accordance with the method described below in the Examples (Axial Pull).

In some approaches, the plant-based cheese product has a stretch of at least 20 mm at 80° C. In other approaches, the plant-based cheese product has a stretch of at least 25 mm at 80° C., at least 30 mm at 80° C., or at least 35 mm at 80° C. In these approaches, the stretch at 80° C. of the plant-based cheese product may be considered to be consistent with consumer expectations for the stretch at 80° C. of a conventional (dairy-based) processed cheese and/or a dairy-based semi-hard natural cheese (e.g., a dairy-based natural mild cheddar cheese).

The plant-based cheese product, the plant-based protein, the waxy starch, the fat, the wax, the ethyl cellulose, and the acidulant may each be described above in any of the examples disclosed herein.

Cheeses may be cooked and processed using any conventional equipment, including the use of a laydown cooker, kettle, or other device. Shredding and packaging may also be accomplished with conventional equipment.

To further illustrate the present disclosure, examples are given herein. It is to be understood that these examples are provided for illustrative purposes and are not to be construed as limiting the scope of the present disclosure.

### EXAMPLES

### Preparation of Example Plant-Based Cheese Products

In the following Examples, each of the example plant-based cheese products were prepared according to the following method.

Each example plant-based cheese product included a plant-based protein, a waxy starch, a fat, water, and an acidulant. Each example plant-based cheese product included about 16 to 18 wt % crude protein, based on a total weight of the plant-based cheese product.

The total volume of water was put into a large beaker followed by the addition of the appropriate amount of dry plant-based protein to make a 5% (w/v) aqueous protein mixture. The aqueous mixture was mixed on a stir plate at 400 rpm until combined. The total amount of fat was melted until liquid. The melted fat was poured in to the 5% protein aqueous mixture and homogenized at 20,000 rpm using a Polytron® handheld homogenizer (POLYTRON® PT 1300D V3, KINEMATICA) for 1 minute. An emulsion was formed. The emulsion was added to a Thermomix® TM6™ thermomixer and mixed at speed of 2 to 2.5. During this time, half of the remaining dry plant-based protein and half of the dry waxy starch were added to the thermomixer, and mixed until fully combined and no dry powder remained. An acidulant solution was added to the thermomixer and mixed for 30 seconds. Then, the remaining dry plant-based protein and dry waxy starch were added and mixed until smooth. The mixing was stopped, and the sides were scraped when necessary to ensure proper mixing. Each resulting mixture was between 160 g and 170 g.

Once the mixture was completely smooth, the heating method was started. Each example plant-based cheese product in Examples 1 through 8 and example 412 in Example 11 was produced according to one of the following heating methods (i.e., T1, T2, T3, T4, T5, T6, or T7)

For each heating method (T1, T2, T3, T4, T5, T6, or T7), the Thermomix® TM6™ thermomixer was set to a speed of 2.0 and to a temperature of 40° C. Upon reaching 40° C., the set temperature was increased to 50° C. Upon reaching 50° C., the set temperature was increased to 60° C. Upon reaching 60° C., the set temperature was increased to 70° C. Upon reaching 70° C., the mixing was stopped, and the bottom of the thermomixer was scraped.

Then, the thermomixer was set to a speed of 0.5 and to a temperature of 80° C. Upon reaching 80° C., the mixing was stopped, and the bottom of the thermomixer was scraped. The thermomixer was again set to a speed of 0.5 and to a temperature of 80° C. After mixing for 30 seconds, the mixing was stopped, and the bottom of the thermomixer was scraped. Then, the thermomixer was set to a speed of 3.5 and to a temperature of 80° C. After mixing for 30 seconds, the mixing was stopped, and the bottom of the thermomixer was scraped. Then, the thermomixer was set to a speed of 0.5 and to a temperature of 80° C. After mixing for 1 minute and 30 seconds, the mixing was stopped, and the bottom of the thermomixer was scraped. Then, the thermomixer was again set to a speed of 0.5 and to a temperature of 80° C. After mixing for 1 minute and 30 seconds, the mixing was stopped, and the bottom of the thermomixer was scraped.

Then, the thermomixer was set to a speed of 0.5 and to a temperature of 80° C. After mixing for 30 seconds, the thermomixer was set to a speed of 2.0. After mixing for 30 seconds, the thermomixer was set to a speed of 3.5. After mixing for 30 seconds, the thermomixer was set to a speed of 2.5. After mixing for 30 seconds, the thermomixer was set to a speed of 1.5. After mixing for 1 minute, the mixing was stopped, and the bottom of the thermomixer was scraped.

The example plant-based cheese products that were produced according to heating method T1 were taken at this point from the thermomixer and cooled. The heating method T1 lasted for about 14 minutes.

For the example plant-based cheese products that were produced according to heating methods T2, T3, T4, T5, T6, or T7, the thermomixer was set to a speed of 0.5 and to a temperature of 80° C. After mixing for 2 minutes, the mixing was stopped, and the bottom of the thermomixer was scraped.

The example plant-based cheese products that were produced according to heating method T2 were taken at this point from the thermomixer and cooled. The heating method T2 lasted for about 16 minutes.

For the example plant-based cheese products that were produced according to heating methods T3, T4, T5, T6, or T7, the thermomixer was set to a speed of 0.5 and to a temperature of 80° C. After mixing for 2 minutes, the mixing was stopped, and the bottom of the thermomixer was scraped.

The example plant-based cheese products that were produced according to heating method T3 were taken at this point from the thermomixer and cooled. The heating method T3 lasted for about 18 minutes.

For the example plant-based cheese products that were produced according to heating methods T4, T5, T6, or T7, the thermomixer was set to a speed of 0.5 and to a temperature of 80° C. After mixing for 2 minutes, the mixing was stopped, and the bottom of the thermomixer was scraped.

The example plant-based cheese products that were produced according to heating method T4 were taken at this point from the thermomixer and cooled. The heating method T4 lasted for about 20 minutes.

For the example plant-based cheese products that were produced according to heating methods T5, T6, or T7, the thermomixer was set to a speed of 0.5 and to a temperature of 80° C. After mixing for 2 minutes, the mixing was stopped, and the bottom of the thermomixer was scraped.

The example plant-based cheese products that were produced according to heating method T5 were taken at this point from the thermomixer and cooled. The heating method T5 lasted for about 22 minutes.

For the example plant-based cheese products that were produced according to heating methods T6 or T7, the thermomixer was set to a speed of 0.5 and to a temperature of 80° C. After mixing for 2 minutes, the mixing was stopped, and the bottom of the thermomixer was scraped.

The example plant-based cheese products that were produced according to heating method T6 were taken at this point from the thermomixer and cooled. The heating method T6 lasted for about 24 minutes.

For the example plant-based cheese products that were produced according to heating method T7, the thermomixer was set to a speed of 0.5 and to a temperature of 80° C. After mixing for 2 minutes, the mixing was stopped, and the bottom of the thermomixer was scraped.

The example plant-based cheese products that were produced according to heating method T7 were taken at this point from the thermomixer and cooled. The heating method T7 lasted for about 26 minutes.

After the heating method, each example plant-based cheese product was refrigerated for 24 hours at temperature of 4° C. to 5° C.

### Texture Analysis

Texture profile analysis (TPA) is a standard technique used to obtain sensory characteristics of food. TPA mimics the first two bites of chewing by compressing the food to a desired level of deformation. The TPA test was used to determine the hardness of the example plant-based cheese products, commercial plant-based cheeses, and commercial dairy-based cheeses. The hardness of each sample was equal to the peak force of the first compression.

For the analysis of the example plant-based cheese products, samples were prepared using a cylindrical die cutter with a 20 mm diameter, followed by trimming to 10 mm in height. For commercial samples that were pre-sliced, the die cutter was used to cut samples which were then stacked to reach 10 mm in height. All samples were kept at 5° C. and analyzed within 1 to 5 minutes of being cut. The sample disks were analyzed using a TA.XT2 texture analyzer (Stable Micro systems, Texture Technologies Corp. Scarsdale, NY, USA) fitted with a 75 mm cylindrical plate and 30 kg load cell. The samples were compressed to 50% of their original height at a crosshead speed of 1.00 mm/s with 5 seconds rest between compressions. The data was recorded in newtons and analyzed using Exponent software.

### Disk Melt Test (Modified Schreiber Test)

The meltability (i.e., melt percentage) of the example plant-based cheese products, commercial plant-based cheeses, and commercial dairy-based cheeses was measured using a modified Schreiber test. Samples were cut with a cylindrical 20 mm die cutter, then trimmed to be 10 mm in height. Samples that were in slice form were cut to be the same 20 mm in diameter and stacked to be 10 mm in height. The samples were kept at 5° C. For each sample, a template 100 mm in diameter was printed with increasing concentric circles as well as lines at 45° angels on white printer paper. The template was placed at the bottom of a petri dish facing up. The sample was then placed on top of the template and covered with the corresponding glass top and placed in the refrigerator at 5° C. for 10 minutes. The samples were then transferred to an oven pre heated to 232° C. (i.e., 450° F.) for 5 minutes. The samples were removed and allowed to cool before the diameter of the spread at four different angles was taken. The average of the measurement was used to calculate the meltability by determining the % increase in diameter from the initial 20 mm.

### Oil Loss

Oil loss for the example plant-based cheese products, commercial plant-based cheeses, and commercial dairy-based cheeses was measured based on the saturation of Schreiber disk paper that occurred during the melt. A numeric value from 1 to 7 was allotted based on the number of rings on the paper that were saturated with oil.

### Rheometer Temperature Sweep

Oscillatory shear strain tests and temperature sweeps were performed on the example plant-based cheese products, commercial plant-based cheeses, and commercial dairy-based cheeses using a rotational rheometer (MRC 302, Anton Paar, Graz, Austria) fit with a 20 mm parallel plate geometry (PP20/S). To avoid slip, the top and bottom plates were affixed with 40 and 600 grit sandpaper, respectively, and a small amount of super glue was used to adhere the sample. The samples were less than 3 mm in height and were compressed between the plates with an axial force not exceeding 5 N. The normal force was then reduced to 0.25 N and held for 3 minutes to allow the sample to relax. Peltier plates and a forced air hood (Anton Paar, Graz, Austria) were used to control the temperature.

Amplitude sweeps were first performed at 5° C., 25° C. and 50° C. on commercial Kraft® Singles slices to determine the liner viscoelastic region (LVR). The sweep was performed at a logarithmic rate from 0.01 to 200% strain as a constant frequency of 1 Hz.

A frequency sweep from 1 to 10 Hz was then carried at 0.1% strain.

To investigate the melting profile of the example plant-based cheese products, commercial plant-based cheeses, and commercial dairy-based cheeses, a temperature sweep from 5 to 80° C. at a rate of 5° C. per minute was carried out at 0.1% strain, at a frequency of 1 Hz with a constant normal force of 0.25 N to adjust for sample melting.

The variables obtained for all tests were elastic modulus (or storage modulus) (G′), loss modulus (or plastic modulus) (G″) and Tan δ (i.e., G″/G′) and the data was analyzed using RheoCompass™ Software.

### Axial Pull

The extensibility or stretch of the example plant-based cheese products, commercial plant-based cheeses, and commercial dairy-based cheeses was measured using a rotational rheometer (MRC 302, Anton Paar, Graz, Austria) with Peltier plates and a forced air hood (Anton Paar, Graz, Austria) used for temperature control. The rheometer was fit with a 20 mm parallel plate geometry (PP20/S) and pre-heated to 80° C. To avoid slip, the top and bottom plates were affixed with 40 and 600 grit sandpaper, respectively, and a small amount of super glue was used to adhere the sample. 5 mm samples were used and compressed between the plates with an axial force not exceeding 5 N. The normal force was then reduced to 0.25 N. The samples were held for a total of 6 minutes at 80° C. with a constant 0.1% strain and applied normal force 0.25 N. The applied force ensured constant contact with the sample during melting, as the gap decrease was limited to a height of 3 mm. After heating, an axial pull was performed where the top parallel plate geometry moved upwards at a speed of 1500 μm/s. The Normal force (N) and Gap (mm) was recorded during the pull using RheoCompass™ Software.

Additionally, a video recording of the axial pull was done using the camera of an iphone XS (Apple Inc.). The gap size of the instrument was recorded in the same frame as sample stretch, and the gap at which the sample broke was used as the break point. Total stretch was measured by the following equation:

$$Stretch ( mm ) = Breakpoint ( mm ) - Starting gap after heating ( mm )$$

### Example 1

First, the hardness, melt percentage, and oil loss of commercial dairy-based cheeses, Kraft® Singles (a processed cheese which included 15-20% crude protein) and Cracker Barrel® Natural (mild/medium) Cheddar (which included 25-30% crude protein) were measured. The results of these measurements are shown in Table 2.

TABLE 2

| Commercial | | Melt | |
|---|---|---|---|
| Dairy-Based | Hardness | Percentage | |
| Cheese | (N) | (%) | Oil Loss |
| Kraft ® Single | 20 ± 1.0 | 151 | 0 |
| Cracker Barrel ® | 83 ± 6.8 | 183 | 7 |
| Natural Cheddar | | | |

Then, examples of the plant-based cheese product disclosed herein were prepared. The example plant-based cheese products had the general formula S1, S2, S3, S4, or S5 and were prepared with heating method T3, T4, T5, T6, or T7. A 1 M citric acid solution was added as the acidulant to each example plant-based cheese product in an amount effective to keep the pH below 5.5.

The faba protein isolate was obtained from AGT Food & Ingredients and included about 90% crude protein. The lupin protein isolate was obtained from ProLupin GmbH and included about 91% crude protein. The soy protein isolate included about 88% crude protein and was obtained from DuPont. The soy protein concentrate included about 84% crude protein and was obtained from DuPont. The mungbean protein isolate was obtained from Fuji Plant Protein Labs and included about 85% crude protein. The native waxy maize was 100% Waxy Maize Starch obtained from MyProtein. The coconut oil was refined, organic, non-GMO coconut oil (Nutiva® Nurture Vitality™, Nutiva Inc., Richmond, CA).

Each of the formulas S1, S2, S3, S4, and S5 is shown in Table 3, with the wt % of each ingredient that was used (based on the total weight of the plant-based cheese product).

TABLE 3

| Ingre- | Specific | S1 | S2 | S3 | S4 | S5 |
|---|---|---|---|---|---|---|
| dient | Component | (wt %) | (wt %) | (wt %) | (wt %) | (wt %) |
| Plant- | Faba Protein | 18 | — | — | — | — |
| based | Isolate | | | | | |
| Protein | Lupin | — | 18 | — | — | — |
| | Protein | | | | | |
| | Isolate | | | | | |
| | Soy Protein | — | — | 19 | — | — |
| | Isolate | | | | | |
| | Soy Protein | — | — | — | 19 | — |
| | Concentrate | | | | | |
| | Mungbean | — | — | — | — | 19 |
| | Protein | | | | | |
| | Isolate | | | | | |
| Waxy | Native | 12 | 12 | 12 | 12 | 12 |
| Starch | Waxy | | | | | |
| | Maize | | | | | |
| Fat | Coconut | 21 | 21 | 21 | 21 | 21 |
| | Oil | | | | | |
| Water | Water | 49 | 49 | 48 | 48 | 48 |

The hardness, melt percentage, and oil loss of the example plant-based cheese products were measured. The results of the hardness measurements are shown in Table 4. The results of the melt percentage measurements are shown in Table 5. The results of the oil loss measurements are shown in Table 6. In each of Tables 4 through 6, each example plant-based cheese product is identified by the formula and the heating method used to prepare the example plant-based cheese product.

TABLE 4
(Hardness in N)

| | T3 | T4 | T5 | T6 | T7 |
|---|---|---|---|---|---|
| S1 (Faba) | 12 | 19 | 29 | 46 | 79 |
| S2 (Lupin) | — | 19 | 29 | — | — |
| S3 (Soy Isolate) | 19 | 34 | 51 | 68 | 85 |
| S4 (Soy Concentrate) | 34 | 36 | 45 | 77 | 86 |
| S5 (Mungbean) | 15 | 19 | 22 | 32 | 53 |

TABLE 5
(Melt Percentage in %)

| | T3 | T4 | T5 | T6 | T7 |
|---|---|---|---|---|---|
| S1 (Faba) | 87 | 98 | 96 | 87 | 65 |
| S2 (Lupin) | — | 0 | 0 | — | — |
| S3 (Soy Isolate) | 48 | 45 | 73 | 35 | 34 |
| S4 (Soy Concentrate) | 70 | 50 | 53 | 41 | 51 |
| S5 (Mungbean) | 81 | 31 | 53 | 73 | 50 |

TABLE 6
(Oil Loss)

| | T3 | T4 | T5 | T6 | T7 |
|---|---|---|---|---|---|
| S1 (Faba) | 3 | 6 | 5 | 6 | 3 |
| S2 (Lupin) | — | 1 | 1 | — | — |
| S3 (Soy Isolate) | 5 | 4 | 4 | 6 | 4 |
| S4 (Soy Concentrate) | 6 | 5 | 5 | 5 | 6 |
| S5 (Mungbean) | 5 | 3 | 6 | 6 | 4 |

### Hardness

The hardness of the example plant-based cheese products (Table 4) was similar across the different protein isolates. All formulas were able to reach hardness values similar to that of the Kraft® Singles (about 20N), except for formula S4, containing soy protein concentrate, which had a higher hardness value at T3. All formulas were also able to reach hardness values similar to the Cracker Barrel® Natural Cheddar, except for formula S5, containing mungbean protein. The mungbean protein provided consistently lower hardness values than the other proteins. It is believed that the mungbean protein isolate may have included pregelatinized starch, which may have resulted in the lower hardness values. Accordingly, longer heat treatments may be required to provide plant-based cheeses with a higher hardness value when mungbean (or another protein ingredient that includes pregelatinized starch) is, or is one of, the plant-based proteins in the plant-based cheese.

The hardness values indicates that multiple plant-based proteins can be used for creating the plant-based cheese product.

### Melt

Sample meltability is an important indicator to the viability of the protein for use in the formulation. The goal is to have a large spread occur during the melting process, in order to be similar to commercially available dairy-based cheese.

As shown in Table 5, the meltability of the formulas varied. However, formula S1, containing faba protein, had significant melt. The other formulas, except for formula S2, containing lupin protein, were able to achieve some melt.

### Oil Loss

All the samples experienced oil loss during the melting (Table 6). Formula S2, containing lupin protein experiencing the least oil loss. This may be attributed to the samples having no melt or softening, which suggests that the lupin protein may interact with or bind the oil in a different way. The oil loss that is observed for the formulas containing other proteins is acceptable for the samples prepared by heating methods T6 and T7, as they have hardness values similar to the Cracker Barrel® Natural Cheddar, which also experienced significant oil loss.

Overall, the samples containing the faba protein isolate had the best meltability, with an achievable hardness range that can be similar to both a Kraft® Singles and Cracker Barrel® Natural Cheddar depending on the amount of heating applied. The oil loss observed for all samples was more similar to that of a natural cheese over a processed cheese.

### Example 2

Additional examples of the plant-based cheese product were prepared. The example plant-based cheese products had the general formula S6 and were prepared with heating method T3, T4, T5, T6, or T7. The zein protein isolate was added during the ramping of the thermomixer from a speed of 0.5 for 30 seconds, to a speed of 2.0 for 30 seconds, to a speed of 3.5 for 30 seconds, to a speed of 2.5 for 30 seconds, then to a speed of 1.5 for 1 minute. A 1 M citric acid solution was added as the acidulant to each example plant-based cheese product in an amount effective to keep the pH below 5.5.

The faba protein isolate was obtained from AGT Food & Ingredients and included about 90% crude protein. Zein protein (food grade) from corn (FloZein Products, Ashburnham, MA) was used as the zein protein isolate and included about 82-100% crude protein. The native waxy maize was 100% Waxy Maize Starch obtained from MyProtein. The coconut oil was refined, organic, non-GMO coconut oil (Nutiva® Nurture Vitality™, Nutiva Inc., Richmond, CA).

The formula S6 is shown in Table 7, with the wt % of each ingredient that was used (based on the total weight of the plant-based cheese product).

TABLE 7

| | Specific | S6 |
|---|---|---|
| Ingredient | Component | (wt %) |
| Plant-based | Faba Protein | 17 |
| Protein | Isolate | |
| | Zein Protein | 1 |
| | Isolate | |
| Waxy Starch | Native Waxy | 12 |
| | Maize | |
| Fat | Coconut Oil | 21 |
| Water | Water | 49 |

The hardness, melt percentage, and oil loss of the example plant-based cheese products prepared with formula S6 were measured. The results of the hardness, melt percentage, and oil loss measurements are shown in Table 8. In Table 8, each example plant-based cheese product is identified by the heating method used to prepare the example plant-based cheese product.

TABLE 8

| | T3 | T4 | T5 | T6 | T7 |
|---|---|---|---|---|---|
| Hardness | 9 | 15 | 20 | 46 | 92 |
| (N) | | | | | |
| Melt Percentage | 109 | 114 | 96 | 85 | 53 |
| (%) | | | | | |
| Oil Loss | 6 | 5 | 6 | 6 | 4 |

The samples had hardness values in the hardness range that would be similar to processed and natural cheeses. For the samples prepared with heating methods T3 and T4, the melt slightly increased over the samples prepared with formula S1 and heating methods T3 and T4, but the sample hardness was also slightly softer, which could indicate an easier ability to melt and deform. The melt of the sample prepared with heating method T6 was not different from the sample prepared with formula S1 and heating method T6, but the melt of the sample prepared with heating method T7 decreased over the sample prepared with formula S1 and heating method T7. The sample prepared with heating method T7 also had greater hardness over the sample prepared with formula S1 and heating method T7. The samples prepared with formula S6 also had oil loss similar to the samples prepared with formula S1.

### Example 3

Additional examples of the plant-based cheese product were prepared. The example plant-based cheese products had the general formula S7, S8, S9, S10, S11, or S12 and were prepared with heating method T3, T4, T5, T6, or T7. As shown in Table 9 below, each formula had an “additive” ingredient (lupin protein isolate, flax protein concentrate, faba protein concentrate, lecithin, or zein protein isolate) in addition to a faba protein ingredient. The additive was used in the initial emulsion, except for the zein protein isolate, which was instead added at the beginning of the mixing process with the other dry ingredients. A 1 M citric acid solution was added as the acidulant to each example plant-based cheese product in an amount effective to keep the pH below 5.5.

The faba protein isolate was obtained from AGT Food & Ingredients (about 90% crude protein by weight of the isolate). The milled faba protein was produced by ball milling the dry faba protein isolate for 72 hours at −20° C. Before milling, the particle size in the faba protein isolate ranged from 25 μm to 17 μm. After milling the particle size decreased to 10 μm to 90 μm.

The lupin protein isolate was obtained from ProLupin GmbH (about 91% crude protein by weight of the isolate). The flax protein concentrate was obtained from Glanbia (about 26% crude protein by weight of the concentrate). The faba protein concentrate was obtained from Ingredion (about 60% crude protein by weight of the concentrate). The lecithin was Sunlec®25 (Perimondo LLC, Florida, New York, USA) (about 0% crude protein by weight). Zein protein (food grade) from corn (FloZein Products, Ashburnham, MA) was used as the zein protein isolate (about 82-100% crude protein by weight of the isolate).

The native waxy maize w was 100% Waxy Maize Starch obtained from MyProtein. The coconut oil was refined, organic, non-GMO coconut oil (Nutiva® Nurture Vitality™, Nutiva Inc., Richmond, CA).

Each of the formulas S7, S8, S9, S10, S11, and S12 is shown in Table 9, with the wt % of each ingredient that was used (based on the total weight of the plant-based cheese product).

TABLE 9

| | Specific | S7 | S8 | S9 | S10 | S11 | S12 |
|---|---|---|---|---|---|---|---|
| Ingredient | Component | (wt %) | (wt %) | (wt %) | (wt %) | (wt %) | (wt %) |
| Plant-based Protein | Faba Protein | 13 | 16 | 16 | 18 | — | 18 |
| | Isolate | | | | | | |
| | Milled Faba | — | — | — | — | 18 | — |
| | Protein | | | | | | |
| Additive | Lupin Protein | 5 | — | — | — | — | — |
| | Isolate | | | | | | |
| | Flax Protein | — | 2 | — | — | — | — |
| | Concentrate | | | | | | |
| | Faba Protein | — | — | 2 | — | — | — |
| | Concentrate | | | | | | |
| | Lecithin | — | — | — | 0.2 | — | — |
| | Zein Protein | — | — | — | — | — | 0.5 |
| | Isolate | | | | | | |
| Waxy Starch | Native Waxy | 12 | 12 | 12 | 12 | 12 | 12 |
| | Maize | | | | | | |
| Fat | Coconut Oil | 21 | 21 | 21 | 21 | 21 | 21 |
| Water | Water | 49 | 49 | 49 | 49 | 49 | 49 |

The hardness, melt percentage, and oil loss of the example plant-based cheese products were measured. The results of the hardness measurements are shown in Table 10. The results of the melt percentage measurements are shown in Table 11. The results of the oil loss measurements are shown in Table 12. In each of Tables 10 through 12, each example plant-based cheese product is identified by the formula and the heating method used to prepare the example plant-based cheese product.

TABLE 10
(Hardness in N)

| | T3 | T4 | T5 | T6 | T7 |
|---|---|---|---|---|---|
| S7 (Faba and Lupin) | 9 | 18 | 33 | 60 | 103 |
| S8 (Faba and Flax) | 11 | 17 | 29 | 47 | 78 |
| S9 (Faba and Faba | 9 | 15 | 23 | 45 | 66 |
| Concentrate) | | | | | |
| S10 (Faba and | 15 | 26 | 42 | 52 | 69 |
| Lecithin) | | | | | |
| S11 (Milled Faba) | 12 | 15 | 24 | 35 | 58 |
| S12 (Faba and Zein) | 27 | 29 | 37 | 54 | 60 |

TABLE 11
(Melt Percentage in %)

| | T3 | T4 | T5 | T6 | T7 |
|---|---|---|---|---|---|
| S7 (Faba and Lupin) | 34 | 73 | 25 | 41 | 54 |
| S8 (Faba and Flax) | 108 | 95 | 98 | 73 | 75 |
| S9 (Faba and Faba | 121 | 114 | 95 | 98 | 80 |
| Concentrate) | | | | | |
| S10 (Faba and | 121 | 116 | 106 | 101 | 89 |
| Lecithin) | | | | | |
| S11 (Milled Faba) | 95 | 99 | 110 | 84 | 76 |
| S12 (Faba and Zein) | 100 | 86 | 96 | 84 | 80 |

TABLE 12
(Oil Loss)

| | T3 | T4 | T5 | T6 | T7 |
|---|---|---|---|---|---|
| S7 (Faba and Lupin) | 2 | 4 | 3 | 4 | 4 |
| S8 (Faba and Flax) | 6 | 6 | 2 | 3 | 4 |
| S9 (Faba and Faba | 6 | 5 | 5 | 5 | 4 |
| Concentrate) | | | | | |
| S10 (Faba and | 6 | 6 | 7 | 6 | 6 |
| Lecithin) | | | | | |
| S11 (Milled Faba) | 7 | 5 | 5 | 5 | 5 |
| S12 (Faba and Zein) | 7 | 6 | 6 | 7 | 6 |

The samples prepared with formula S7 (faba plus lupin) had some reductions in oil loss and reductions in the melt as compared to the samples prepared with formula S1 (all faba).

The samples prepared with formula S8 (faba plus flax) and heating methods T5 and T6 resulted in a slight reduction of oil loss as compared to the samples prepared with formula S1 (all faba) and heating methods T5 and T6.

The samples prepared with formula S9 (faba protein isolate plus faba protein concentrate) and heating methods T3, T4, T6, and T7 had increased meltability as compared to the samples prepared with formula S1 and heating methods T3, T4, T6, and T7. The sample prepared with formula S9 and heating method T7 had slightly decreased hardness over the sample prepared with formula S1 (all faba) and heating method T7. The samples prepared with formula S9 had similar oil loss to the samples prepared with formula S1.

The samples prepared with formula S10 (faba protein isolate plus lecithin) had increased meltability and increased oil loss as compared to the samples prepared with formula S1 (all faba). The samples prepared with formula S10 had lower hardness compared to the Cracker Barrel® Natural Cheddar.

The samples prepared with formula S11 (milled faba protein plus lecithin) had melt and oil loss similar to the melt and oil loss of the samples prepared with formula S1 (all faba). The samples prepared with formula S11 also had lower hardness as compared to the samples prepared with formula S1.

The samples prepared with formula S12 (faba protein isolate plus zein protein isolate) had a hardness slightly higher than Kraft® Singles but lower than Cracker Barrel® Natural Cheddar. The samples prepared with formula S12 also did not reduce the oil loss as compared to the samples prepared with formula S1.

### Example 4

Additional examples of the plant-based cheese product were prepared. The example plant-based cheese products had the general formula S13, S14, S15, S16, S17, S18, S19, or S20 and were prepared with heating method T3, T4, T5, T6, or T7. A 1 M citric acid solution was added as the acidulant to each example plant-based cheese product in an amount effective to keep the pH below 5.5.

The faba protein isolate was obtained from AGT Food & Ingredients (about 90% crude protein by weight of the isolate). The native waxy maize was 100% Waxy Maize Starch obtained from MyProtein.

The sunflower oil was Selection™ sunflower oil (Imported for Metro Brands, Montreal (Quebec), Toronto (Ontario)). The coconut oil was refined, organic, non-GMO coconut oil (Nutiva® Nurture Vitality™, Nutiva Inc., Richmond, CA). The cocoa butter was refined and bleached cocoa butter (JB Cocoa Sdn. Bhd. (Johor, Malaysia)). The shea stearin and the shea olein were each obtained from AAK® (Malmo, Sweden).

The cotton seed glycerolysis product was produced from a reaction in which cottonseed oil in combination with glycerol undergoes a chemical reaction to produce a product that is high in monoglycerides (MGs) and diglycerides (DGs). The cotton seed glycerolysis product was obtained from the University of Guelph (Ontario, Canada).

Each of the formulas S13, S14, S15, S16, S17, S18, S19, and S20 is shown in Table 13, with the wt % of each ingredient that was used (based on the total weight of the plant-based cheese product).

TABLE 13

| | Specific | S13 | S14 | S15 | S16 | S17 | S18 | S19 | S20 |
|---|---|---|---|---|---|---|---|---|---|
| Ingredient | Component | (wt %) | (wt %) | (wt %) | (wt %) | (wt %) | (wt %) | (wt %) | (wt %) |
| Plant- | Faba Protein | 18 | 18 | 18 | 19 | 18 | 18 | 18 | 18 |
| based | Isolate | | | | | | | | |
| Protein | | | | | | | | | |
| Waxy | Native Waxy | 12 | 12 | 12 | 13 | 12 | 12 | 12 | 12 |
| Starch | Maize | | | | | | | | |
| Fat | Sunflower | 21 | — | — | — | — | — | — | — |
| | Oil | | | | | | | | |
| | 70% Coconut | — | 21 | — | — | — | — | — | — |
| | Oil and 30% | | | | | | | | |
| | Sunflower | | | | | | | | |
| | Oil | | | | | | | | |
| | Coconut Oil | — | — | 15 | 16 | — | — | — | — |
| | Cocoa Butter | — | — | — | — | 21 | — | — | — |
| | 50% | — | — | — | — | — | 21 | — | — |
| | Cottonseed | | | | | | | | |
| | Glycerolysis | | | | | | | | |
| | and 50% | | | | | | | | |
| | Coconut Oil | | | | | | | | |
| | 50% Shea | — | — | — | — | — | — | 21 | — |
| | Stearin and | | | | | | | | |
| | 50% Coconut | | | | | | | | |
| | Oil | | | | | | | | |
| | 50% Shea | — | — | — | — | — | — | — | 21 |
| | Stearin and | | | | | | | | |
| | 50% Shea | | | | | | | | |
| | Olein | | | | | | | | |
| Water | Water | 49 | 49 | 55 | 52 | 49 | 49 | 49 | 49 |

The hardness, melt percentage, and oil loss of the example plant-based cheese products were measured. The results of the hardness measurements are shown in Table 14. The results of the melt percentage measurements are shown in Table 15. The results of the oil loss measurements are shown in Table 16. In each of Tables 14 through 16, each example plant-based cheese product is identified by the formula and the heating method used to prepare the example plant-based cheese product.

TABLE 14
(Hardness in N)

| | T3 | T4 | T5 | T6 | T7 |
|---|---|---|---|---|---|
| S13 (Sunflower Oil) | 7 | 12 | 14 | 21 | 39 |
| S14 (Coconut Oil | 6 | 9 | 16 | 20 | 33 |
| and Sunflower Oil) | | | | | |
| S15 (Coconut Oil) | | | | 11 | 19 |
| S16 (Coconut Oil) | 11 | 17 | 27 | 41 | 98 |
| S17 (Cocoa Butter) | 18 | 25 | 41 | 63 | 64 |
| S18 (Cottonseed | 7 | 11 | 14 | 22 | 29 |
| Glycerolysis and | | | | | |
| Coconut Oil) | | | | | |
| S19 (Shea Stearin | 9 | 13 | 21 | 29 | 47 |
| and Coconut Oil) | | | | | |
| S20 (Shea Stearin | 5 | 8 | 13 | 16 | 47 |
| and Shea Olein) | | | | | |

TABLE 15
(Melt Percentage in %)

| | T3 | T4 | T5 | T6 | T7 |
|---|---|---|---|---|---|
| S13 (Sunflower Oil) | 73 | 66 | 80 | 76 | 88 |
| S14 (Coconut Oil | 100 | 82 | 95 | 73 | 80 |
| and Sunflower Oil) | | | | | |
| S15 (Coconut Oil) | 0 | 0 | 0 | 53 | 86 |
| S16 (Coconut Oil) | 94 | 93 | 76 | 80 | 49 |
| S17 (Cocoa Butter) | 69 | 94 | 89 | 75 | 51 |
| S18 (Cottonseed | 95 | 96 | 94 | 76 | 76 |
| Glycerolysis and | | | | | |
| Coconut Oil) | | | | | |
| S19 (Shea Stearin | 113 | 88 | 94 | 98 | 84 |
| and Coconut Oil) | | | | | |
| S20 (Shea Stearin | 95 | 97 | 51 | 93 | 58 |
| and Shea Olein) | | | | | |

TABLE 16
(Oil Loss)

| | T3 | T4 | T5 | T6 | T7 |
|---|---|---|---|---|---|
| S13 (Sunflower Oil) | 0 | 0 | 0 | 5 | 6 |
| S14 (Coconut Oil | 4 | 5 | 5 | 4 | 5 |
| and Sunflower Oil) | | | | | |
| S15 (Coconut Oil) | | | | 0 | 4 |
| S16 (Coconut Oil) | 3 | 4 | 3 | 4 | 2 |
| S17 (Cocoa Butter) | 4 | 5 | 5 | 5 | 4 |
| S18 (Cottonseed | 6 | 6 | 7 | 7 | 6 |
| Glycerolysis and | | | | | |
| Coconut Oil) | | | | | |
| S19 (Shea Stearin | 7 | 5 | 6 | 7 | 6 |
| and Coconut Oil) | | | | | |
| S20 (Shea Stearin | 1 | 1 | 1 | 1 | 1 |
| and Shea Olein) | | | | | |

The samples prepared with formula S13 (sunflower oil) were able to achieve a similar hardness to processed cheese when the T6 heating method was used. The samples prepared with formula S13 also had less melt and reduced oil loss as compared to the samples prepared with formula S1 (coconut oil). This is likely due to the samples being incredibly soft and paste-like, allowing for better oil-binding.

The samples prepared with formula S14 (70% coconut oil/30% sunflower oil) were able to achieve a similar hardness to processed cheese when the T6 heating method was used. The samples prepared with formula S14 also had less melt than the samples prepared with formula S1 and experienced oil loss.

The samples prepared with formula S15 (coconut oil) had reduced fat and increased water contents compared to formulas S13 and S14. The samples prepared with formula S15 were able to achieve a similar hardness to processed cheese when the T7 heating method was used. The samples prepared with formula S15 also had less melt than the samples prepared with formula S1 and experienced oil loss.

The samples prepared with formula S16 (coconut oil) had reduced fat and increased plant-based protein and waxy starch compared to formulas S13 and S14. The samples prepared with formula S16 had similar hardness and melt to the samples prepared with formula S1. The samples prepared with formula S16 also had some reductions in oil loss as compared to the samples prepared with formula S1, likely due to a lower amount of oil being present in the formulation.

The samples prepared with formula S17 (cocoa butter) had a hardness and meltability similar to the samples prepared with formula S1. The samples prepared with formula S17 also experienced slightly less oil loss than the samples prepared with formula S1. This may be due to the different crystallization of the cocoa butter, or because it tends to be a more viscous oil, which could have slightly changed how it was structured in the sample.

The samples prepared with formula S18 (50% cottonseed glycerolysis/50% coconut oil) had decreased hardness as compared to the samples prepared with formula S1. The samples prepared with formula S18 also had good meltability, but a large amount of oil loss.

The samples prepared with formula S19 (50% shea stearin/50% coconut oil) had decreased hardness as compared to the samples prepared with formula S1. The samples prepared with formula S19 also had good meltability, but a large amount of oil loss. The visual appeal of the samples was very similar to what is desired in the appearance of processed cheese.

The samples prepared with formula S20 (50% shea stearin/50% shea olein) had low hardness. The samples prepared with formula S20 were able to melt and exhibited only a small amount of oil loss.

### Example 5

Additional examples of the plant-based cheese product were prepared. The example plant-based cheese products had the general formula S21, S22, S23, S24, S25, S26, or S27 and were prepared with heating method T3, T4, T5, T6, or T7. A 1 M citric acid solution was added as the acidulant to each example plant-based cheese product in an amount effective to keep the pH below 5.5.

In some of the example plant-based cheese products, ethyl cellulose (EC) was used to make an oleogel to use as the fat. To make the EC oleogels, the oil (e.g., coconut oil) and EC powder were heated to about 140° C., which is above the glass transition temperature of EC to allow the polymer to form an open conformation and create a network that physically entraps the liquid oil phase. The sample was heated at 140° C. until no visible EC particles remain (approximately 20 minutes). The ethyl cellulose (EC) used was 45 cp ETHOCEL™ Standard 45 (The Dow Chemical Company, Michigan, USA).

In some of the example plant-based cheese products, a wax (beeswax or candelilla wax) was used to structure the oil and make an oleogel, which was then used as the fat. The beeswax was Yellow Beeswax NF PAC (KOSTER KEUNEN®, Watertown, Connecticut, USA). The candelilla wax was Candelilla Wax NF (KOSTER KEUNEN®, Watertown, Connecticut, USA).

The faba protein isolate was obtained from AGT Food & Ingredients (about 90% crude protein by weight of the isolate). The native waxy maize was Waxy No 1 obtained from Tate & Lyle. The coconut oil was refined, organic, non-GMO coconut oil (Nutiva® Nurture Vitality™, Nutiva Inc., Richmond, CA). The shea stearin was obtained from AAK® (Malmo, Sweden).

Each of the formulas S21, S22, S23, S24, S25, S26, and S27 is shown in Table 17, with the wt % of each ingredient that was used (based on the total weight of the plant-based cheese product). The amount of the EC or wax indicated was based on the total weight of the fat.

TABLE 17

| | Specific | S21 | S22 | S23 | S24 | S25 | S26 | S27 |
|---|---|---|---|---|---|---|---|---|
| Ingredient | Component | (wt %) | (wt %) | (wt %) | (wt %) | (wt %) | (wt %) | (wt %) |
| Plant- | Faba Protein | 18 | 18 | 18 | 18 | 18 | 18 | 18 |
| based | Isolate | | | | | | | |
| Protein | | | | | | | | |
| Waxy | Native | 12 | 12 | 12 | 12 | 12 | 12 | 12 |
| Starch | Waxy Maize | | | | | | | |
| Fat | 2% EC in | 21 | — | — | — | — | — | — |
| | Coconut Oil | | | | | | | |
| | 1% EC in | — | 21 | — | — | — | — | — |
| | Coconut Oil | | | | | | | |
| | 0.5% EC in | — | — | 21 | — | — | — | — |
| | Coconut Oil | | | | | | | |
| | 0.1% EC in | — | — | — | 21 | — | — | — |
| | Coconut Oil | | | | | | | |
| | 1% EC in | — | — | — | — | 21 | — | — |
| | 50% Shea | | | | | | | |
| | Stearin and | | | | | | | |
| | 50% | | | | | | | |
| | Coconut Oil | | | | | | | |
| | 2% Beeswax | — | — | — | — | — | 21 | — |
| | in Coconut | | | | | | | |
| | Oil | | | | | | | |
| | 2% | — | — | — | — | — | — | 21 |
| | Candelilla | | | | | | | |
| | wax in | | | | | | | |
| | Coconut Oil | | | | | | | |
| Water | Water | 49 | 49 | 49 | 49 | 49 | 49 | 49 |

The hardness, melt percentage, and oil loss of the example plant-based cheese products were measured. The results of the hardness measurements are shown in Table 18. The results of the melt percentage measurements are shown in Table 19. The results of the oil loss measurements are shown in Table 20. In each of Tables 18 through 20, each example plant-based cheese product is identified by the formula and the heating method used to prepare the example plant-based cheese product.

TABLE 18
(Hardness in N)

| | T3 | T4 | T5 | T6 | T7 |
|---|---|---|---|---|---|
| S21 (2% EC in | 8 | 10 | 16 | 25 | 38 |
| Coconut Oil) | | | | | |
| S22 (1% EC in | 12 | 19 | 29 | 46 | 81 |
| Coconut Oil) | | | | | |
| S23 (0.5% EC in | 12 | 16 | 28 | 40 | 91 |
| Coconut Oil) | | | | | |
| S24 (0.1% EC in | 8 | 9 | 16 | 25 | 52 |
| Coconut Oil) | | | | | |
| S25 (1% EC in 50% | | | | 22 | 41 |
| Shea Stearin and | | | | | |
| 50% Coconut Oil) | | | | | |
| S26 (2% Beeswax in | 11 | 16 | 29 | 48 | 82 |
| Coconut Oil) | | | | | |
| S27 (2% Candelilla | 9 | 12 | 24 | 36 | 80 |
| wax in Coconut Oil) | | | | | |

TABLE 19
(Melt Percentage in %)

| | T3 | T4 | T5 | T6 | T7 |
|---|---|---|---|---|---|
| S21 (2% EC in | 49 | 58 | 56 | 84 | 44 |
| Coconut Oil) | | | | | |
| S22 (1% EC in | 78 | 98 | 58 | 76 | 67 |
| Coconut Oil) | | | | | |
| S23 (0.5% EC in | 64 | 60 | 49 | 51 | 39 |
| Coconut Oil) | | | | | |
| S24 (0.1% EC in | 113 | 64 | 88 | 89 | 78 |
| Coconut Oil) | | | | | |
| S25 (1% EC in 50% | | | | 115 | 75 |
| Shea Stearin and | | | | | |
| 50% Coconut Oil) | | | | | |
| S26 (2% Beeswax in | 88 | 83 | 78 | 93 | 64 |
| Coconut Oil) | | | | | |
| S27 (2% Candelilla | 106 | 99 | 96 | 94 | 84 |
| wax in Coconut Oil) | | | | | |

TABLE 20
(Oil Loss)

| | T3 | T4 | T5 | T6 | T7 |
|---|---|---|---|---|---|
| S21 (2% EC in | 0 | 0 | 0 | 0 | 0 |
| Coconut Oil) | | | | | |
| S22 (1% EC in | 0 | 0 | 0 | 0 | 0 |
| Coconut Oil) | | | | | |
| S23 (0.5% EC in | 0 | 0 | 0 | 0 | 1 |
| Coconut Oil) | | | | | |
| S24 (0.1% EC in | 0 | 0 | 0 | 1 | 1 |
| Coconut Oil) | | | | | |
| S25 (1% EC in 50% | | | | 0 | 0 |
| Shea Stearin and | | | | | |
| 50% Coconut Oil) | | | | | |
| S26 (2% Beeswax in | 3 | 3 | 3 | 5 | 3 |
| Coconut Oil) | | | | | |
| S27 (2% Candelilla | 0 | 0 | 0 | 3 | 4 |
| wax in Coconut Oil) | | | | | |

In the samples prepared with formulas S21 through S24, different concentrations of EC in coconut oil were explored and used as oleogels in the samples. The samples prepared with formulas S21 through S24 were able to reach hardness levels similar to that of processed cheese, but only the samples prepared with formulas S22 (1% EC in coconut oil) and S23 (0.5% EC in coconut oil) reached hardness values close to that of the Cracker Barrel® Natural Cheddar. The meltability for all the samples prepared with formulas S21 through S24 also had slight decreases as compared to the samples prepared with formula S1. However, the samples with hardness values similar to the processed cheese had good meltability relative to the meltability of the samples prepared with formula S1. The samples prepared with formulas S21 (2% EC in coconut oil) and S24 (0.1% EC in coconut oil) had no oil loss observed. For the samples prepared with formulas S22 (1% EC in coconut oil) and S23 (0.5% EC in coconut oil), there was little to no oil loss, with only small amounts observed for the samples with greater hardness values.

The samples prepared with formula S25 (1% EC in 50% shea stearin/50% coconut oil) achieved hardness values that were similar to that of the processed cheese, but it did not get hard enough to be similar to the natural cheese. The samples prepared with formula S25 did have good meltability, and the addition of EC to the formula prevented oil loss.

The samples prepared with formulas S26 (2% beeswax in coconut oil) and S27 (2% candelilla wax in coconut oil) had similar hardness ranges and reached the levels of both the processed cheese and natural cheese. The samples prepared with formulas S26 and S27 also had good meltability, with the samples prepared with formula S27 (2% candelilla wax in coconut oil) having melt values similar to or exceeding the melt values of the samples prepared with formula S1. The oil loss, however, was different between the samples prepared with formula S26 and the samples prepared with formula S27. The samples prepared with formula S26 (2% beeswax in coconut oil) experienced oil loss, though it was less than the oil loss of the samples prepared with formula S1. The samples prepared with formula S27 (2% candelilla wax in coconut oil) experience less oil loss. In particular, samples prepared with formula S27 and heating methods T3 through T5 had no oil loss, and samples prepared with formula S27 and heating methods T6 and T7 had only small amounts of oil loss. It was found that the addition of waxes could modulate the oil loss in the samples.

Overall, it was found that structuring the oil using waxes and oleogelators (e.g., EC) can modulate the oil loss while keeping good meltability and hardness.

### Comparative Example 6

The hardness, melt percentage, and oil loss of commercial plant-based cheeses were also measured. The commercial plant-based cheeses were “mild cheddar analogues” from Earth Island® (NON-GMO Cheddar Style Slices, Cheese Alternative. Product of Greece. Manufactured for Earth Island®, Chatsworth, CA.), Daiya® (Daiya® Cheddar flavour slices (DAIYA FOODS INC., Burnaby, BC)), Sheese® (Sheese® Vegan, Mature Cheddar style Slices, Non-dairy Simulated Cheese Product. KLBD Pareve. Made By: Rothesay Isle of Bute, Scotland, U.K.), and VioLife® (Violife® Cheddar Style Slices alternative to cheese. Produced in Greece By: ARIVIA S.A. Block 31 Industrial Area of Sindos, Thessaloniki, Greece). The results of these measurements are shown in Table 21.

TABLE 21

| | | Melt | |
|---|---|---|---|
| Commercial Plant- | Hardness | Percentage | |
| Based Cheese | (N) | (%) | Oil Loss |
| Earth Island ® Mild Cheddar | 103 | 3 | 0 |
| Analogue | | | |
| Daiya ® Mild Cheddar | 55 | 1 | 0 |
| Analogue | | | |
| Sheese ® Mild Cheddar | 106 | 21 | 0 |
| Analogue | | | |
| VioLife ® Mild Cheddar | 119 | 14 | 0 |
| Analogue | | | |

The hardness values of all of the commercial plant-based cheeses, except for the Daiya® plant-based cheese, were significantly greater than both the dairy-based processed cheese and the Cracker Barrel® Natural Cheddar. The meltability of all of the commercial plant-based cheeses was also significantly lower than the processed cheese, the Cracker Barrel® Natural Cheddar, and the samples prepared with formula S1. There was no oil loss observed in any of the commercial plant-based cheeses, which was similar to the oil loss of the processed cheese but not the Cracker Barrel® Natural Cheddar.

Overall, the samples prepared with formulas S22, S23 S26, and S27 (Example 5) better matched the hardness values of the processed cheese and the Cracker Barrel® Natural Cheddar than the commercial plant-based cheeses, while having superior meltability and no oil loss.

### Example 7

Rheometer temperature sweeps were performed for the Kraft® Singles (a processed cheese), the Cracker Barrel® Natural Cheddar, the example plant-based cheese products prepared with formulas S1, S22, S26, and S27 and heating methods T3 through T7, and the commercial plant-based cheeses from Comparative Example 6 (i.e., the mild cheddar analogues from Earth Island®, Daiya®, Sheese®, and VioLife®). The temperature sweep from 5° C. to 80° C. was used to understand the melting profile of the samples. The G′ indicated the solid behavior of the system, while the G″ indicated the viscous portion.

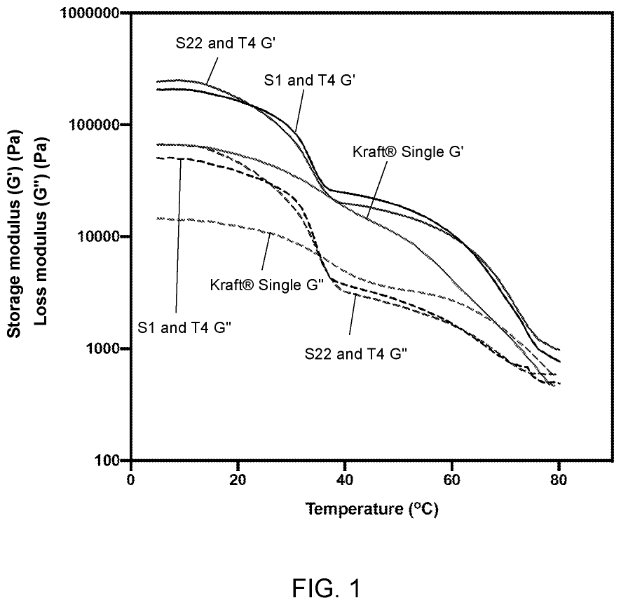

The melting curves produced from the rheometer temperature sweeps of the Kraft® Singles (a processed cheese), the example plant-based cheese product prepared with formula S1 and heating method T4, and the example plant-based cheese product prepared with formula S22 and heating method T4 are shown in FIG. 1. The Kraft® Singles and the samples prepared with formulas S1 and S22 and the heating method T4 each had a hardness value between 19 N and 21 N. In FIG. 1, each example plant-based cheese product is identified by the formula and the heating method used to prepare the example plant-based cheese product.

As shown in FIG. 1, the Kraft® Singles had a steady melting curve with the G′ and G″ steadily decreasing and the crossover of the G′ and G″ occurring around 70° C. The crossover of the G′ and G″ of the Kraft® Singles indicated that the sample had fully melted and was completely viscous.

As also shown in FIG. 1, the samples prepared with formulas S1 and S22 and the heating method T4 had melting profiles with the G′ steadily decreasing and two main melting events, one around 30° C. and another around 65° C. These temperatures align with the melting of coconut oil (30° C.) and the gelatinization of starch (65° C.). The melting curves for the samples prepared with formulas S1 and S22 and the heating method T4 did not have any cross over of the G′ and G″, which indicated that the samples remained more solid than viscous.

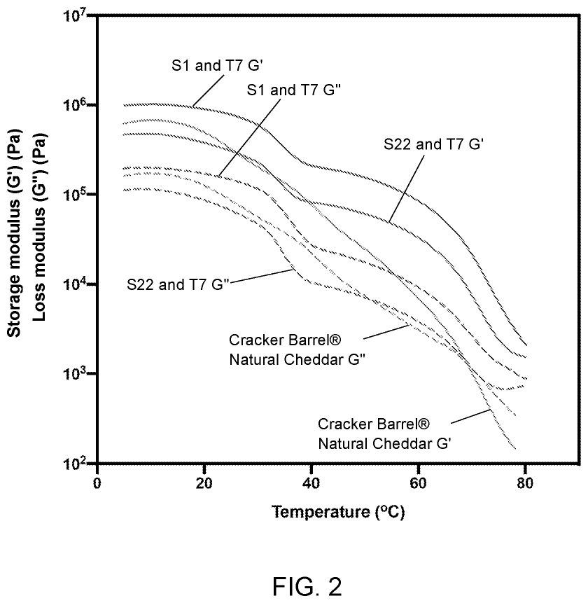

The melting curves produced from the rheometer temperature sweeps of the Cracker Barrel® Natural Cheddar, the example plant-based cheese product prepared with formula S1 and heating method T7, and the example plant-based cheese product prepared with formula S22 and heating method T7 are shown in FIG. 2. The Cracker Barrel® Natural Cheddar and the samples prepared with formulas S1 and S22 and the heating method T7 each had a hardness value between 76 N and 90 N. In FIG. 2, each example plant-based cheese product is identified by the formula and the heating method used to prepare the example plant-based cheese product.

As shown in FIG. 2, the melting profile of the Cracker Barrel® Natural Cheddar was similar to the melting profile of the Kraft® Singles. Both the G′ and G″ of the Cracker Barrel® Natural Cheddar steadily decreased with increasing heat. At about 70° C., the viscous component G″ surpassed that of the solid component G′, indicating that the sample had completely melted.

As also shown in FIG. 2, the samples prepared with formulas S1 and S22 and the heating method T7 had melting profiles similar to the samples prepared with formulas S1 and S22 and the heating method T4, in which two melting events occurred. The results shown in FIG. 2 suggest that increased sample hardness affects the ability for the sample to melt.

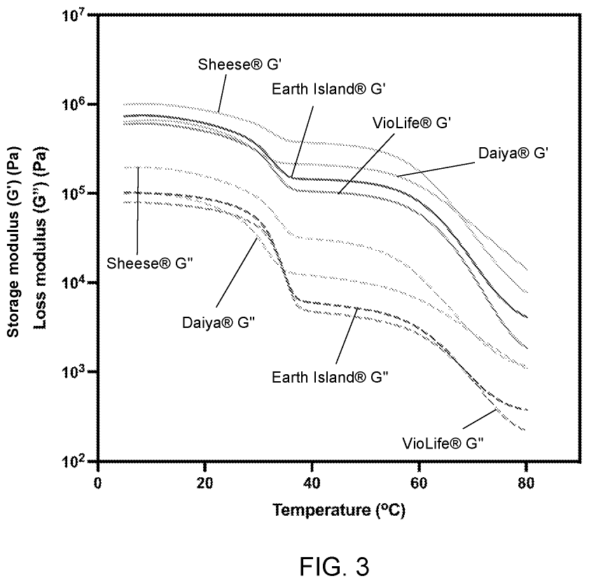

The melting curves produced from the rheometer temperature sweeps of the commercial plant-based cheeses from Comparative Example 6 (i.e., the mild cheddar analogues from Earth Island®, Daiya®, Sheese®, and VioLife®) are shown in FIG. 3. In FIG. 3, each commercial plant-based cheese is identified by its manufacturer.

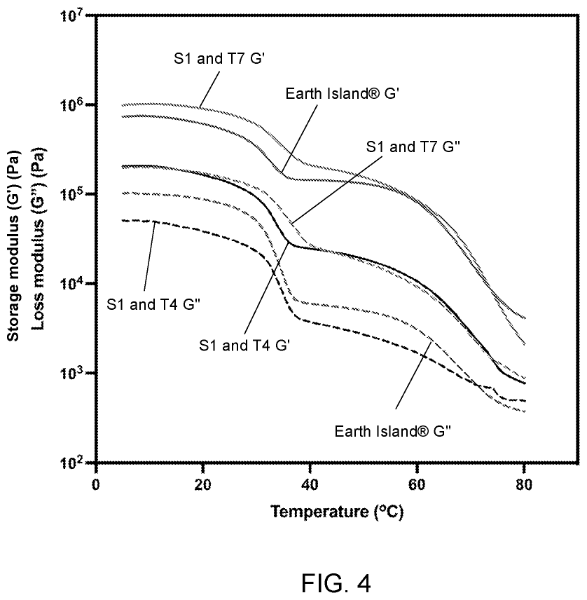

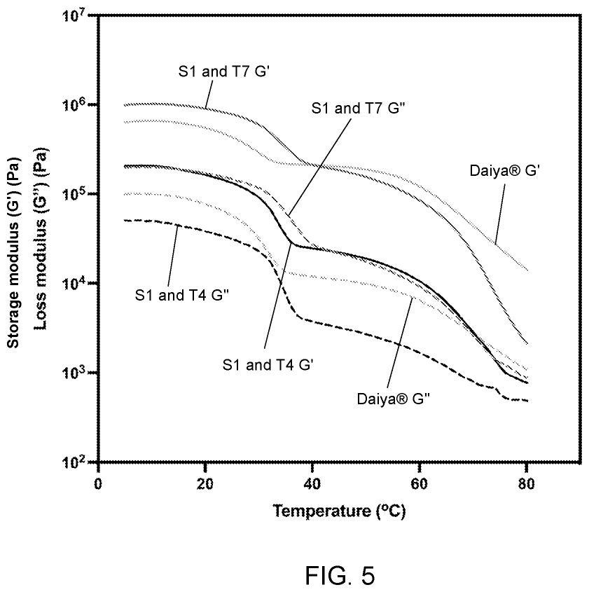

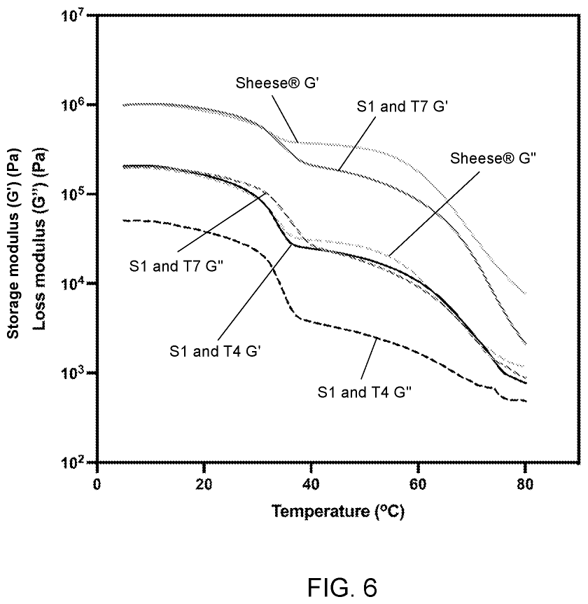

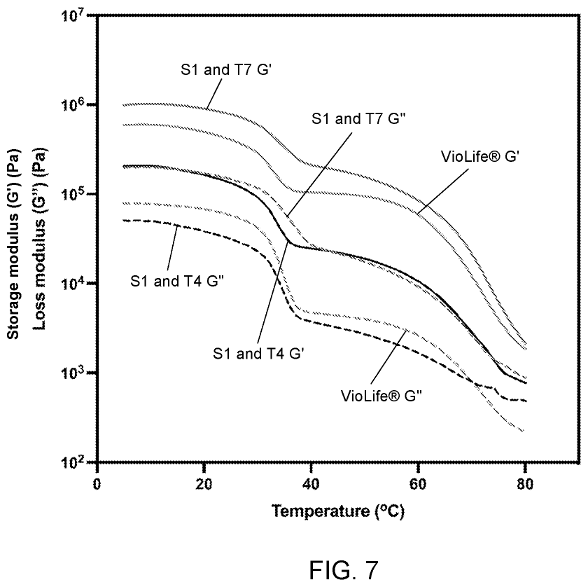

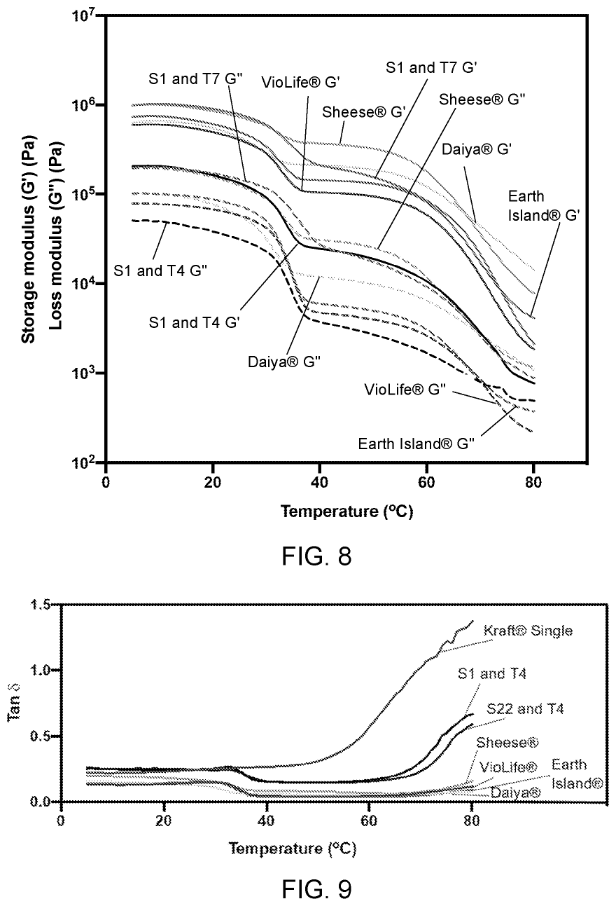

The melting curves produced from the rheometer temperature sweeps of the mild cheddar analogues from Earth Island® (from Comparative Example 6) and the example plant-based cheese products prepared with formulas S1 and S22 and the heating methods T4 and T7 are shown in FIG. 4. The melting curves produced from the rheometer temperature sweeps of the mild cheddar analogues from Daiya® (from Comparative Example 6) and the example plant-based cheese products prepared with formulas S1 and S22 and the heating methods T4 and T7 are shown in FIG. 5. The melting curves produced from the rheometer temperature sweeps of the mild cheddar analogues from Sheese® (from Comparative Example 6) and the example plant-based cheese products prepared with formulas S1 and S22 and the heating methods T4 and T7 are shown in FIG. 6. The melting curves produced from the rheometer temperature sweeps of the mild cheddar analogues from VioLife® (from Comparative Example 6) and the example plant-based cheese products prepared with formulas S1 and S22 and the heating methods T4 and T7 are shown in FIG. 7. The melting curves produced from the rheometer temperature sweeps of the commercial plant-based cheeses from Comparative Example 6 and the example plant-based cheese products prepared with formulas S1 and S22 and the heating methods T4 and T7 are shown in FIG. 8. In FIG. 4 through FIG. 8, each example plant-based cheese product is identified by the formula and the heating method used to prepare the example plant-based cheese product. In FIG. 4 through FIG. 8, each commercial plant-based cheese is identified by its manufacturer.

As shown in FIG. 4 through FIG. 8, the samples prepared with formulas S1 and S22 and the heating methods T4 and T7 had melting profiles similar to the commercial plant-based cheeses. All of the samples had two melting events, which align with the fat melting and starch gelatinizing, respectively. All of the samples had decreasing G′ and G″ with increasing temperature, but no crossover of G′ and G″.

However, it was observed that the G′ and G″ of the example plant-based cheese products were closer in value to each other than the G′ and G″ of commercial plant-based cheeses. In particular, at higher temperatures (e.g., 80° C.), the G′ and G″ of the example plant-based cheese products were significantly closer in value to each other than the G′ and G″ of commercial plant-based cheeses. These results indicate that the example plant-based cheese products prepared with formulas S1 and S22 and the heating methods T4 and T7 underwent greater changes in structure during heating and had more viscous behavior when heated than the commercial plant-based cheeses.

The Tan δ values were determined for the Kraft® Singles processed cheese, the Cracker Barrel® Natural Cheddar, the example plant-based cheese product prepared with formulas S1, S22, S26, and S27 and heating methods T3 through T7, and the commercial plant-based cheeses from Comparative Example 6 (i.e., the mild cheddar analogues from Earth Island®, Daiya®, Sheese®, and VioLife®). Tan δ is the ratio of G″ to G′. Therefore, the G″ and G′ are normalized against each other which removes variability among replicates and allows for a better understanding of the melting profile. As Tan δ moves toward a value of 1, the sample becomes increasingly viscous and has better melting properties.

The Tan δ values as function of temperature (in ° C.) for the Kraft® Singles (a processed cheese), the example plant-based cheese product prepared with formula S1 and heating method T4, the example plant-based cheese product prepared with formula S22 and heating method T4, and the commercial plant-based cheeses from Comparative Example 6 (i.e., the mild cheddar analogues from Earth Island®, Daiya®, Sheese®, and VioLife®) are shown in FIG. 9. The different melting trends of the samples are easily identified in FIG. 9. In FIG. 9, each example plant-based cheese product is identified by the formula and the heating method used to prepare the example plant-based cheese product. In FIG. 9, each commercial plant-based cheese is identified by its manufacturer.

As shown in FIG. 9, the Kraft® Singles had the best overall melting profile as the Tan δ value continually increased with increasing temperature and surpassed the value of 1, indicating a highly viscous network when heated and good meltability. In comparison, the Tan δ values of the commercial plant-based cheeses were significantly lower than the value of 1 and displayed very little increase during heating. These results indicate that, during heating of the commercial plant-based cheeses, very little melting behavior occurred, and while the network may have softened slightly, the solid character of the commercial plant-based cheeses was dominant.

The trend of the Tan δ values of the example plant-based cheese products prepared with formulas S1 and S22 and heating method T4 was more similar to the Kraft® Singles than the commercial plant-based cheeses. As shown in FIG. 9, example plant-based cheese products prepared with formulas S1 and S22 and heating method T4 had increases in the Tan δ with increasing temperature. While the final Tan δ did not reach the value of 1, it did significantly increase and approached the value of 1, which indicates there is more melting and viscous behavior occurring in the heated example plant-based cheese products than in the heated commercial plant-based cheeses. The ability of the example plant-based cheese products to show the increasing Tan δ is significant, as the commercial plant-based cheeses were unable to show this degree of melt and softening of their network.

At 80° C., each of the samples reached their maximum melt or softening. The Tan δ at 80° C. for the example plant-based cheese products prepared with formulas S1, S22, S26, and S27 and heating methods T3 through T7 are shown in Table 22. In Table 22, each example plant-based cheese product is identified by the formula and the heating method used to prepare the example plant-based cheese product. The Tan δ at 80° C. for the Kraft® Singles (a processed cheese), the Cracker Barrel® Natural Cheddar, and the commercial plant-based cheeses from Comparative Example 6 (i.e., the mild cheddar analogues from Earth Island®, Daiya®, Sheese®, and VioLife®) are shown in Table 23.

TABLE 22
(Tan δ at 80° C.)

| | T3 | T4 | T5 | T6 | T7 |
|---|---|---|---|---|---|
| S1 (Faba) | 0.66 | 0.67 | 0.68 | 0.67 | 0.60 |
| S22 (1% Ethyl | 0.65 | 0.61 | 0.59 | 0.55 | 0.48 |
| cellulose (EC) in | | | | | |
| Coconut Oil) | | | | | |
| S26 (2% Beeswax in | 0.65 | 0.64 | 0.73 | 0.69 | 0.63 |
| Coconut Oil) | | | | | |
| S27 (2% Candelilla | 0.66 | 0.65 | 0.63 | 0.62 | 0.61 |
| wax in Coconut Oil) | | | | | |

TABLE 23

| Commercial Dairy-Based | |
|---|---|
| or Plant-Based Cheese | Tan δ at 80° C. |
| Kraft ® Single | 1.42 |
| Cracker Barrel ® Natural Cheddar | 2.25 |
| Earth Island ® Mild Cheddar Analogue | 0.09 |
| Daiya ® Mild Cheddar Analogue | 0.08 |
| Sheese ® Mild Cheddar Analogue | 0.16 |
| VioLife ® Mild Cheddar Analogue | 0.11 |

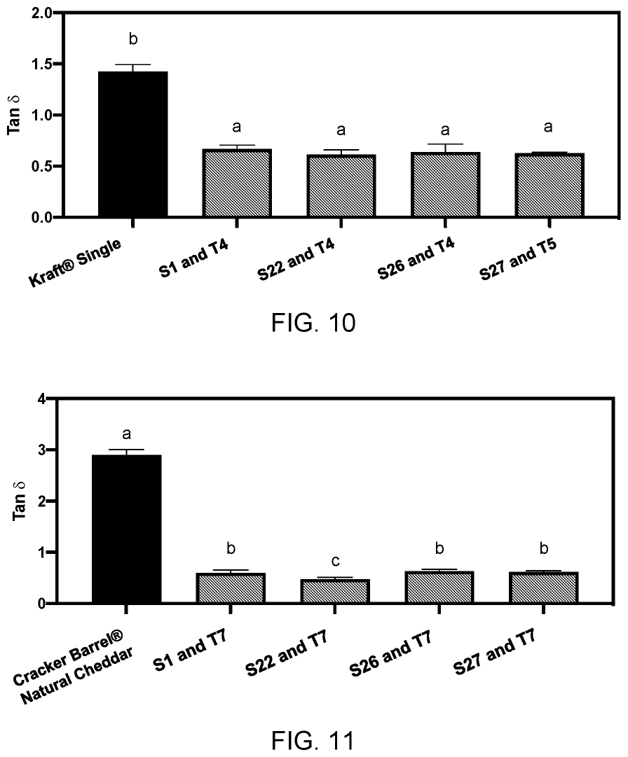

The Tan δ at 80° C. for the Kraft® Singles, the example plant-based cheese product prepared with formula S1 and heating method T4, the example plant-based cheese product prepared with formula S22 and heating method T4, the example plant-based cheese product prepared with formula S26 and heating method T4, and the example plant-based cheese product prepared with formula S27 and heating method T5 are also shown in FIG. 10. The Kraft® Singles and these example plant-based cheese products each had a hardness value between 16 N and 24 N. In FIG. 10, each example plant-based cheese product is identified by the formula and the heating method used to prepare the example plant-based cheese product.

As shown in FIG. 10, the Tan δ values at 80° C. for the example plant-based cheese products were statistically similar, and, while the Tan δ values at 80° C. for the example plant-based cheese products were lower than the Tan δ value at 80° C. for the Kraft® Singles, it has been concluded that using fat modulating additives such as EC and wax does not significantly affect the sample meltability.

The Tan δ at 80° C. for the Cracker Barrel® Natural Cheddar, the example plant-based cheese product prepared with formula S1 and heating method T7, the example plant-based cheese product prepared with formula S22 and heating method T7, the example plant-based cheese product prepared with formula S26 and heating method T7, and the example plant-based cheese product prepared with formula S27 and heating method T7 are also shown in FIG. 11. The Cracker Barrel® Natural Cheddar and these example plant-based cheese products each had a hardness value between 76 N and 90 N. In FIG. 11, each example plant-based cheese product is identified by the formula and the heating method used to prepare the example plant-based cheese product.

As shown in FIG. 11, all of the example plant-based cheese products, except for the sample prepared with formula S22 and heating method T7, had statistically similar Tan δ values at 80° C. Further, it was expected that the Tan δ values at 80° C. for the example plant-based cheese products would be lower than the Tan δ value at 80° C. for the Cracker Barrel® Natural Cheddar, as the high fat and protein content of the Cracker Barrel® Natural Cheddar was expected to result in greater meltability and, thus, greater Tan δ.

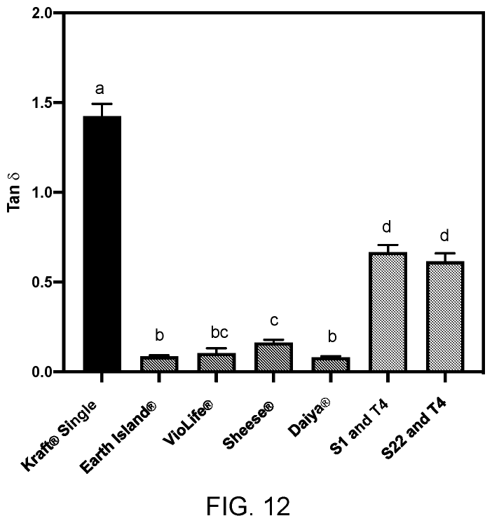

The Tan δ at 80° C. for the Kraft® Singles, the example plant-based cheese product prepared with formula S1 and heating method T4, the example plant-based cheese product prepared with formula S22 and heating method T4, and the commercial plant-based cheeses from Comparative Example 6 (i.e., the mild cheddar analogues from Earth Island®, Daiya®, Sheese®, and VioLife®) are also shown in FIG. 12. In FIG. 12, each example plant-based cheese product is identified by the formula and the heating method used to prepare the example plant-based cheese product. In FIG. 12, each commercial plant-based cheese is identified by its manufacturer.

As shown in FIG. 12, the Tan δ at 80° C. for the Kraft® Singles was significantly greater than both the commercial plant-based cheeses and the example plant-based cheese products. However, the Tan δ values at 80° C. for the example plant-based cheese product prepared with formulas S1 and S22 and heating method T4 were significantly greater than the Tan δ at 80° C. for any of the commercial plant-based cheeses. These results indicate that the example plant-based cheese product prepared with formulas S1 and S22 and heating method T4not only better match the hardness of a Kraft® Singles but also have superior meltability than the commercial plant-based cheeses.

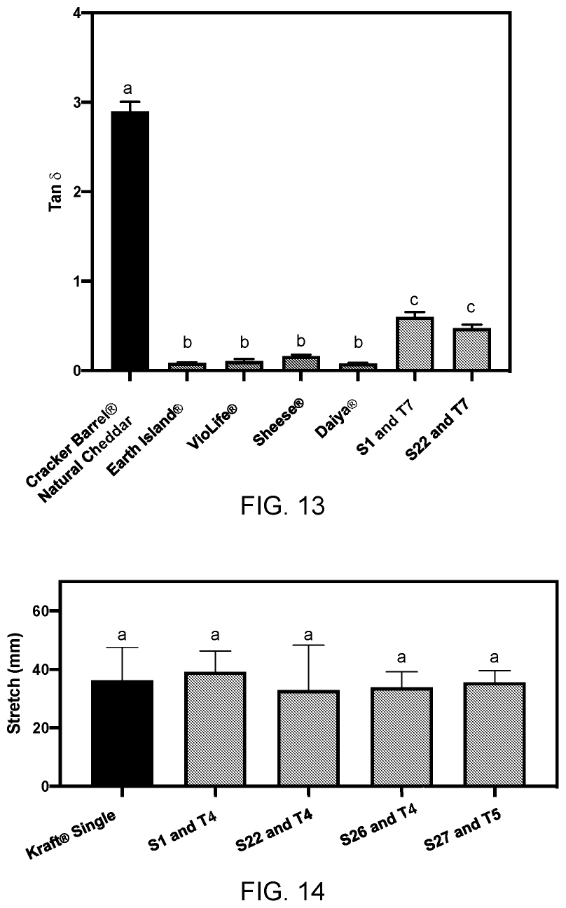

The Tan δ at 80° C. for the Cracker Barrel® Natural Cheddar, the example plant-based cheese product prepared with formula S1 and heating method T7, the example plant-based cheese product prepared with formula S22 and heating method T7, and the commercial plant-based cheeses from Comparative Example 6 (i.e., the mild cheddar analogues from Earth Island®, Daiya®, Sheese®, and VioLife®) are also shown in FIG. 13. In FIG. 13, each example plant-based cheese product is identified by the formula and the heating method used to prepare the example plant-based cheese product. In FIG. 13, each commercial plant-based cheese is identified by its manufacturer.

As shown in FIG. 13, the Tan δ at 80° C. for the Cracker Barrel® Natural Cheddar was significantly greater than both the commercial plant-based cheeses and the example plant-based cheese products. However, the Tan δ values at 80° C. for the example plant-based cheese product prepared with formulas S1 and S22 and heating method T7 were significantly greater than the Tan δ at 80° C. for any of the commercial plant-based cheeses. These results indicate that the example plant-based cheese product prepared with formulas S1 and S22 and heating method T7 can match the hardness of the commercial plant-based cheeses, while having superior meltability.

Overall, the comparison of the Tan δ values clearly demonstrated the superior meltability of the example plant-based cheese products over all of the commercial plant-based cheeses. The maximum Tan δ value at 80° C. reached for the commercial plant-based cheeses was 0.18. The minimum Tan δ value at 80° C. reached for an example plant-based cheese product tested was 0.43.

### Example 8

Axial pulls were performed to measure the stretch of the Kraft® Singles (a processed cheese), the Cracker Barrel® Natural Cheddar, the example plant-based cheese products prepared with formulas S1, S22, S26, and S27 and heating methods T3 through T7 and the commercial plant-based cheeses from Comparative Example 6 (i.e., the mild cheddar analogues from Earth Island®, Daiya®, Sheese®, and VioLife®).

The stretch measurements of the example plant-based cheese products prepared with formulas S1, S22, S26, and S27 and heating methods T3 through T7 are shown in Table 24. In Table 24, each example plant-based cheese product is identified by the formula and the heating method used to prepare the example plant-based cheese product. The stretch measurements of the Kraft® Singles (a processed cheese), the Cracker Barrel® Natural Cheddar, and the commercial plant-based cheeses from Comparative Example 6 (i.e., the mild cheddar analogues from Earth Island®, Daiya®, Sheese®, and VioLife®) are shown in Table 25.

TABLE 24
(Stretch in mm)

| | T3 | T4 | T5 | T6 | T7 |
|---|---|---|---|---|---|
| S1 (Faba) | 38 | 39 | 37 | 34 | 34 |
| S22 (1% EC in | 35 | 33 | 37 | 34 | 40 |
| Coconut Oil) | | | | | |
| S26 (2% Beeswax in | 32 | 34 | 36 | 35 | 35 |
| Coconut Oil) | | | | | |
| S27 (2% Candelilla | 36 | 36 | 36 | 33 | 34 |
| wax in Coconut Oil) | | | | | |

TABLE 25

| Commercial Dairy-Based | |
|---|---|
| or Plant-Based Cheese | Stretch (mm) |
| Kraft ® Single | 36 |
| Cracker Barrel ® Natural Cheddar | 95 |
| Earth Island ® Mild Cheddar Analogue | 6 |
| Daiya ® Mild Cheddar Analogue | 8 |
| Sheese ® Mild Cheddar Analogue | 17 |
| VioLife ® Mild Cheddar Analogue | 12 |

As shown in Table 24, the stretchability of all the example plant-based cheese products were very similar. This result indicates that the addition of EC and wax did not affect the stretchability of the example plant-based cheese products (as compared to the stretchability of example plant-based cheese products prepared with formula S1). This indicates that oil loss can be managed without deleteriously affecting the stretch of the example plant-based cheese product. Additionally, there was very little change in stretch across the T3 through T7 samples with the same formula. This indicates that the sample hardness does not affect the extensibility of the example plant-based cheese product.

The stretch measurements of the Kraft® Singles, the example plant-based cheese product prepared with formula S1 and heating method T4, the example plant-based cheese product prepared with formula S22 and heating method T4, the example plant-based cheese product prepared with formula S26 and heating method T4, and the example plant-based cheese product prepared with formula S27 and heating method T5 are also shown in FIG. 14. The Kraft® Singles and these example plant-based cheese products each had a hardness value between 16 N and 24 N. In FIG. 14, each example plant-based cheese product is identified by the formula and the heating method used to prepare the example plant-based cheese product.

As shown in FIG. 14, stretch measurements of each of the example plant-based cheese products were statistically similar to the stretch of the Kraft® Singles. This is a significant result, which indicates that oil loss can be prevented, while matching the protein value, hardness, and stretch of a Kraft® Singles.

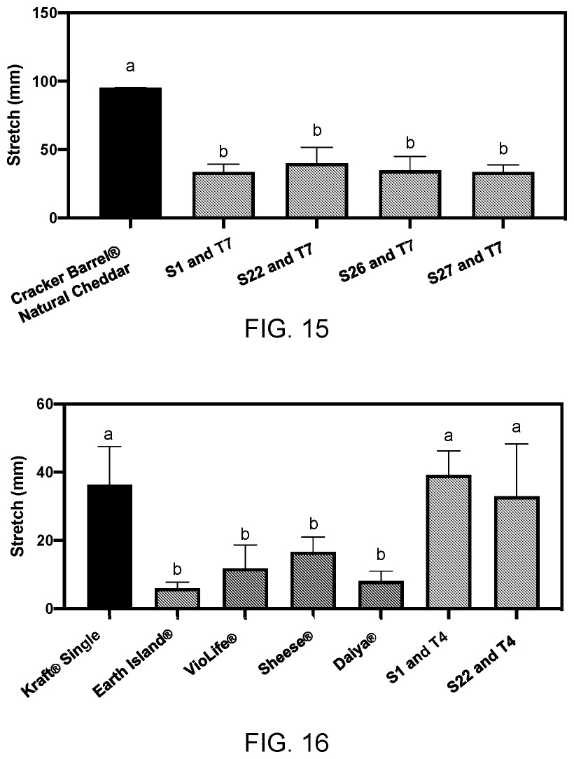

The stretch measurements of the Cracker Barrel® Natural Cheddar, the example plant-based cheese product prepared with formula S1 and heating method T7, the example plant-based cheese product prepared with formula S22 and heating method T7, the example plant-based cheese product prepared with formula S26 and heating method T7, and the example plant-based cheese product prepared with formula S27 and heating method T7 are also shown in FIG. 15. The Cracker Barrel® Natural Cheddar and these example plant-based cheese products each had a hardness value between 76 N and 90 N. In FIG. 15, each example plant-based cheese product is identified by the formula and the heating method used to prepare the example plant-based cheese product.

As shown in FIG. 15, all of the example plant-based cheese products had statistically similar stretch measurements. Further, it was expected that the stretch measurements of the example plant-based cheese products would be lower than the stretch of the Cracker Barrel® Natural Cheddar, as the natural cheese has greater protein content which allowed for greater meltability and stretch.

The stretch measurements of the Kraft® Singles, the example plant-based cheese product prepared with formula S1 and heating method T4, the example plant-based cheese product prepared with formula S22 and heating method T4, and the commercial plant-based cheeses from Comparative Example 6 (i.e., the mild cheddar analogues from Earth Island®, Daiya®, Sheese®, and VioLife®) are also shown in FIG. 16. In FIG. 16, each example plant-based cheese product is identified by the formula and the heating method used to prepare the example plant-based cheese product. In FIG. 16, each commercial plant-based cheese is identified by its manufacturer.

As shown in FIG. 16, all of the commercial plant-based cheeses were statistically similar in the stretchability. However, the stretch measurements of the commercial plant-based cheeses were significantly lower than the stretch measurement of the Kraft® Singles, as well as the stretch measurements of the example plant-based cheese products.

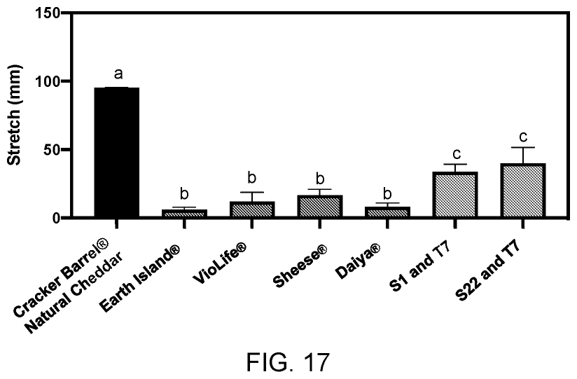

The stretch measurements of the Cracker Barrel® Natural Cheddar, the example plant-based cheese product prepared with formula S1 and heating method T7, the example plant-based cheese product prepared with formula S22 and heating method T7, and the commercial plant-based cheeses from Comparative Example 6 (i.e., the mild cheddar analogues from Earth Island®, Daiya®, Sheese®, and VioLife®) are also shown in FIG. 17. In FIG. 17, each example plant-based cheese product is identified by the formula and the heating method used to prepare the example plant-based cheese product. In FIG. 17, each commercial plant-based cheese is identified by its manufacturer.

As shown in FIG. 17, all the commercial plant-based cheeses had similarly low values of extensibility that were significantly lower than the extensibility of the Cracker Barrel® Natural Cheddar and the extensibility of the example plant-based cheese products.

The ability of the example plant-based cheese products to have significantly greater stretch than all of the commercial plant-based cheeses at both the 16 N to 24 N hardness range and the 76 N to 90 N hardness range is significant. These results further demonstrate that the example plant-based cheese products can outperform the commercial plant-based cheeses. Overall, the Examples demonstrate the successful creation of high protein plant-based cheese products using clean label ingredients. The method used to create the plant-based cheese products enabled a range of hardness values that could be similar to either a Kraft® Singles or Cracker Barrel® Natural Cheddar.

It was determined that the oil modulation can be achieved using ethyl cellulose to create an oleogel as the fat component or by incorporating beeswax or candelilla wax into an oil as the fat component. The oil modulators proved to have no impact on the sample hardness range but did slightly decrease the spread of the sample during melting. The rheological investigation however showed that the melting profile of the plant-based cheese products was not impacted by the oil modulators.

The Tan δ of the systems provided the best comparison of the meltability. The Tan δ of all of the investigated example plant-based cheese products had greater Tan δ values than all of the commercial plant-based cheeses. It was also discovered that all of the example plant-based cheese products with different hardness had similar Tan δ values, indicating that sample hardness does not impact the meltability.

The stretch of the example plant-based cheese products was also investigated and similar trends occurred. The sample hardness and oil modulators did not affect the sample extensibility. The stretch of the example plant-based cheese products was statistically similar to the stretch of the Kraft® Singles. The example plant-based cheese products also had significantly greater stretch than all of the commercial plant-based cheeses.

It was found that the example plant-based cheese products can not only outperform the commercial plant-based cheeses but can also be modulated to have hardness equal to that of the Kraft® Singles with good meltability, no oil loss and equal stretch.

### Example 9

An example plant-based cheese product was prepared with formula S1 and was heated with a jacketed kettle cooker to 88° C. (190° F.) and held at 88° C. (190° F.) for 2 minutes. The example plant-based cheese product was cooled and stored at 5° C.

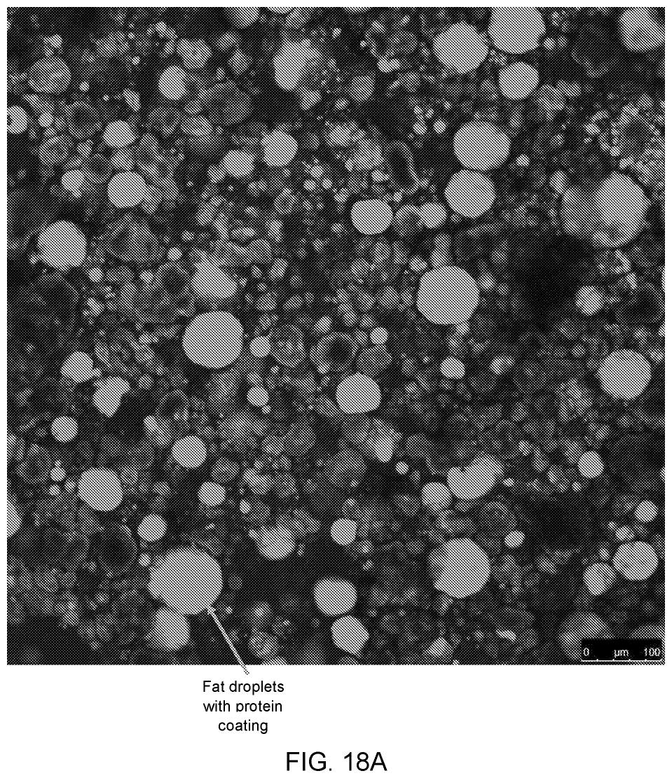

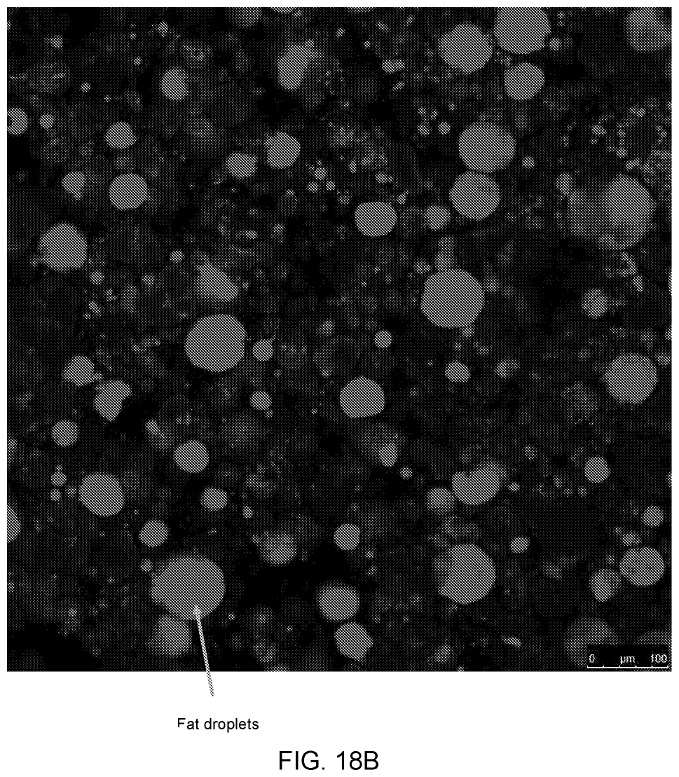

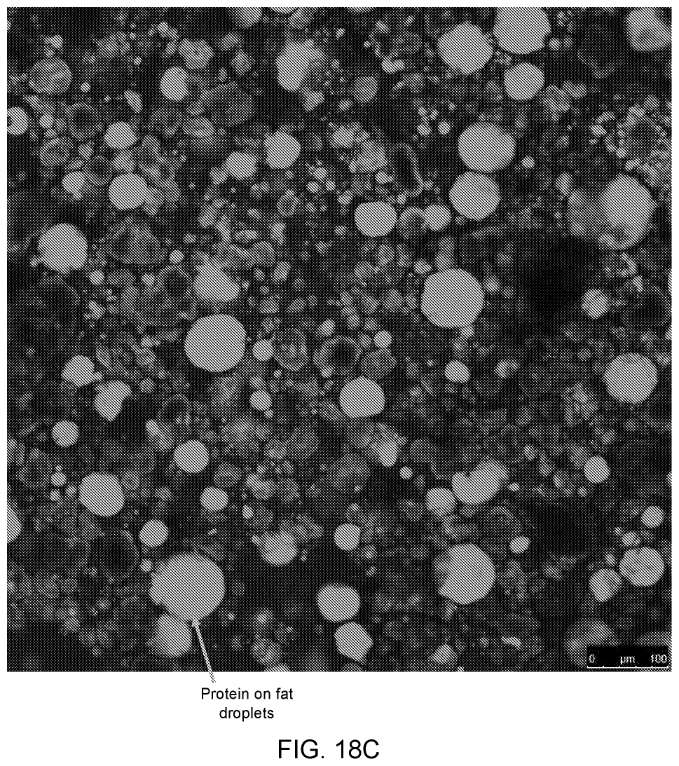

Light microscopy (LM) images were taken of the resulting example plant-based cheese product after 1 week of storage. The sample was stained with fluorescent probes (a mixture of Nile Red and Fast Green FCF in polyethylene glycol solution). The Nile Red was excited with the 488 nm light from an Argon laser and emitted light between 500 nm-600 nm (FIG. 18A and FIG. 18B). The Fast Green FCF was excited with 633 nm light from a HeNe Laser and emitted light between 655-755 nm (FIG. 18A and FIG. 18C). The images were taken at room temperature (about 23° C.) using a Leica SP5 confocal laser scanning microscope and processed by Leica application software (LAS).

The LM images are shown in FIG. 18A through FIG. 18C: FIG. 18A shows both protein and fat; FIG. 18B shows the fat droplets; and FIG. 18C shows the protein.

As can be seen in the figures, the location of the faba protein coincides with the fat droplets, thereby showing that the faba protein is covering the fat droplets and is acting as an emulsifier.

### Example 10

An example plant-based cheese product was prepared with the formula of Table 26 and heating methods T1, T2, T3, T4, and T5.

The chickpea protein concentrate was obtained from Nutriati (about 60% crude protein by weight of the concentrate). The zein protein was obtained from FloZein Products (about 100% crude protein by weight of the isolate). The coconut oil was refined, organic, non-GMO coconut oil (Nutiva® Nurture Vitality™, Nutiva Inc., Richmond, CA).

The chickpea protein concentrate included about 5% starch, which was a waxy starch that included 65-70 wt % amylopectin. The starch was gelatinized during the heating methods.

The formula is shown in Table 26, with the wt % of each ingredient that was used (based on the total weight of the plant-based cheese product).

TABLE 26

| Ingredient | wt % |
|---|---|
| Chickpea protein concentrate | 20 |
| Zein protein | 5 |
| Coconut oil | 15 |
| Water | 60 |

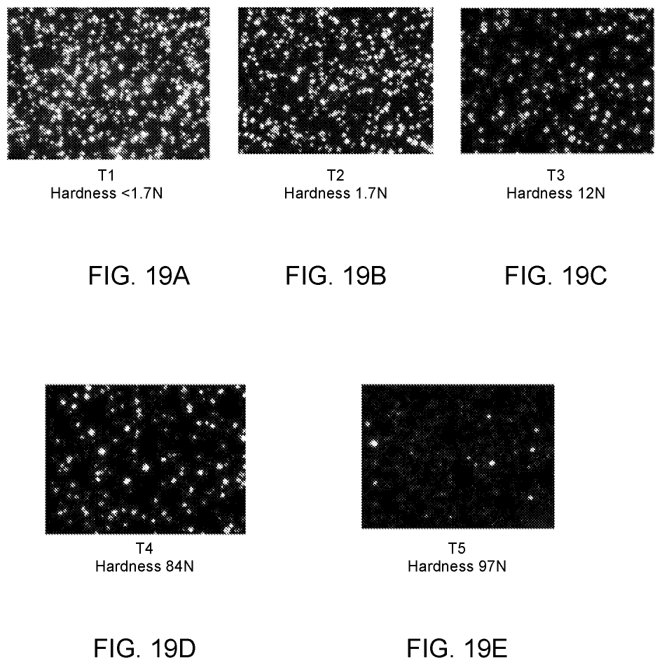

After the heating methods, the samples were cooled and then, viewed under polarized light. Images were taken under polarized light to show birefringent Maltese crosses in white granules and are shown in FIGS. 19A-19E. Higher degree of gelatinization resulted in loss of Maltese crosses.

The hardness values of the sample plant-based cheese prepared with each heating method were also measured. As shown in FIGS. 19A-19E, the hardness values increased as the degree of gelatinization increased, thereby demonstrating how the degree of gelatinization during the cheesemaking process can be used to adjust the hardness of the resulting cheese.

### Example 11

Additional examples of plant-based cheese products (examples 412, 430, 431, 432, and 434) were prepared. The example plant-based cheese products had the general formula shown in Table 27. Example 412 was prepared with heating method T5, and examples 430, 431, 432, and 434 were prepared with heating method “A” (described below). A 1 M citric acid solution was added as the acidulant to each example plant-based cheese product in an amount effective to keep the pH below 5.5.

The canola protein isolate was obtained from Merit Foods (about 90% crude protein by weight of the isolate). The chickpea protein isolate was obtained from ChickP (about 89% crude protein by weight of the isolate). The first pea protein isolate was yellow pea protein isolate obtained from Roquette (about 85% crude protein by weight of the isolate). The second pea protein isolate was yellow pea protein isolate obtained from AGT Food & Ingredients (about 85% crude protein by weight of the isolate). The third pea protein isolate was yellow pea protein isolate obtained from Cargill (about 80% crude protein by weight of the isolate).

The native waxy maize was Waxy No 1 obtained from Tate & Lyle. The coconut oil was refined, organic, non-GMO coconut oil (Nutiva® Nurture Vitality™, Nutiva Inc., Richmond, CA).

Each of the formulas is shown in Table 27, with the wt % of each ingredient that was used (based on the total weight of the plant-based cheese product).

TABLE 27

| | Specific | 412 | 430 | 431 | 432 | 434 |
|---|---|---|---|---|---|---|
| Ingredient | Component | (wt %) | (wt %) | (wt %) | (wt %) | (wt %) |
| Plant-based Protein | Canola | 18 | — | — | — | — |
| | Protein Isolate | | | | | |
| | Chickpea | — | 18 | — | — | — |
| | Protein Isolate | | | | | |
| | First Pea | — | — | 18 | — | — |
| | Protein Isolate | | | | | |
| | Second Pea | — | — | — | 18 | — |
| | Protein Isolate | | | | | |
| | Third Pea | — | — | — | — | 18 |
| | Protein Isolate | | | | | |
| Waxy Starch | Native Waxy | 12 | 12 | 12 | 12 | 12 |
| | Maize | | | | | |
| Fat | Coconut Oil | 21 | 21 | 21 | 21 | 21 |
| Water | Water | 49 | 49 | 49 | 49 | 49 |

For heating method “A,” the Thermomix® TM6™ thermomixer was set to a speed of 2.0 and to a temperature of 40° C. Upon reaching 40° C., the set temperature was increased to 50° C. Upon reaching 50° C., the set temperature was increased to 60° C. Upon reaching 60° C., the set temperature was increased to 70° C. Upon reaching 70° C., the set temperature was increased to 80° C. Upon reaching 80° C., the mixing was stopped, and the bottom of the thermomixer was scraped.

Then, the thermomixer was set to a speed of 0.5 and to a temperature of 90° C. Upon reaching 90° C., the mixing was stopped, and the bottom of the thermomixer was scraped. The thermomixer was again set to a speed of 0.5 and to a temperature of 90° C. After mixing for 30 seconds, the thermomixer was set to a speed of 3.5 and to a temperature of 90° C. After mixing for 30 seconds, the mixing was stopped, and the bottom of the thermomixer was scraped. Then, the thermomixer was set to a speed of 0.5 and to a temperature of 90° C. After mixing for 1 minute and 30 seconds, the mixing was stopped, and the bottom of the thermomixer was scraped. Then, the thermomixer was again set to a speed of 0.5 and to a temperature of 90° C. After mixing for 1 minute and 30 seconds, the mixing was stopped, and the bottom of the thermomixer was scraped.

Then, the thermomixer was set to a speed of 0.5 and to a temperature of 90° C. After mixing for 30 seconds, the thermomixer was set to a speed of 2.0 and to a temperature of 90° C. After mixing for 30 seconds, the thermomixer was set to a speed of 3.5 and to a temperature of 90° C. After mixing for 30 seconds, the thermomixer was set to a speed of 2.5 and to a temperature of 90° C. After mixing for 30 seconds, the thermomixer was set to a speed of 1.5. After mixing for 1 minute, the mixing was stopped, and the bottom of the thermomixer was scraped. Then, the thermomixer was set to a speed of 0.5 and to a temperature of 90° C. After mixing for 2 minutes, the mixing was stopped, and the bottom of the thermomixer was scraped. Then, the thermomixer was again set to a speed of 0.5 and to a temperature of 90° C. After mixing for 2 minutes, the mixing was stopped, and the bottom of the thermomixer was scraped.

The example plant-based cheese products that were produced according to heating method “A” were taken at this point from the thermomixer and cooled to 5° C.

Example 412 did not set and was unable to be cut.

The cold texture of each of the examples 430, 431, 432, and 434 was difficult to cut and was hard and brittle.

The melt of each of the examples 430, 431, 432, and 434 was evaluated according to a Second Schreiber Test. In the Second Schreiber Test, the example plant-based cheese products cut into disc-shaped slices that were about 5 mm ( 3/16 inches) thick and about 50 mm (1.9 inches) in diameter. The slices were placed on wax paper and a circle was drawn around each slice to demarcate the diameter of the slice before heating. Then, the slices were heated in a 232° C. (450° F.) oven for 5 minutes. After heating the amount of spread (outside the drawn circle) was measured. Then, the slices were cooled at room temperature (20° C.) for 30 minutes.

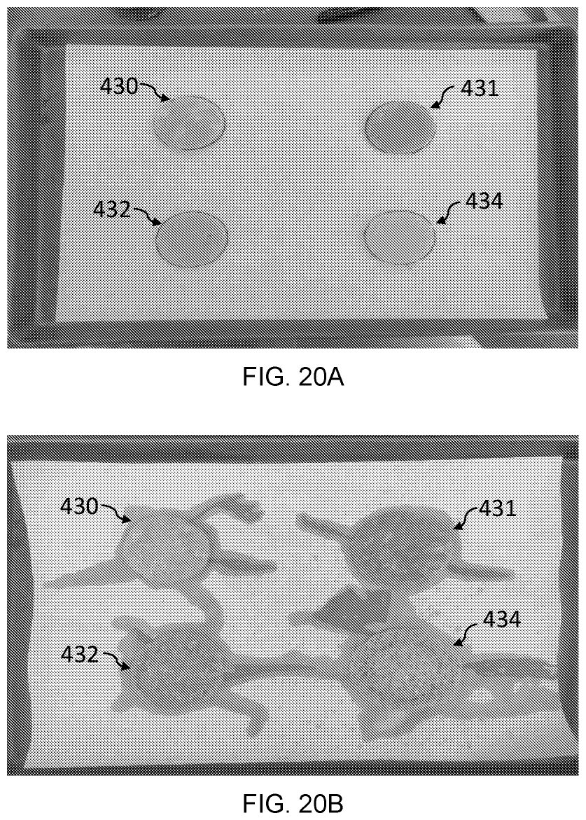

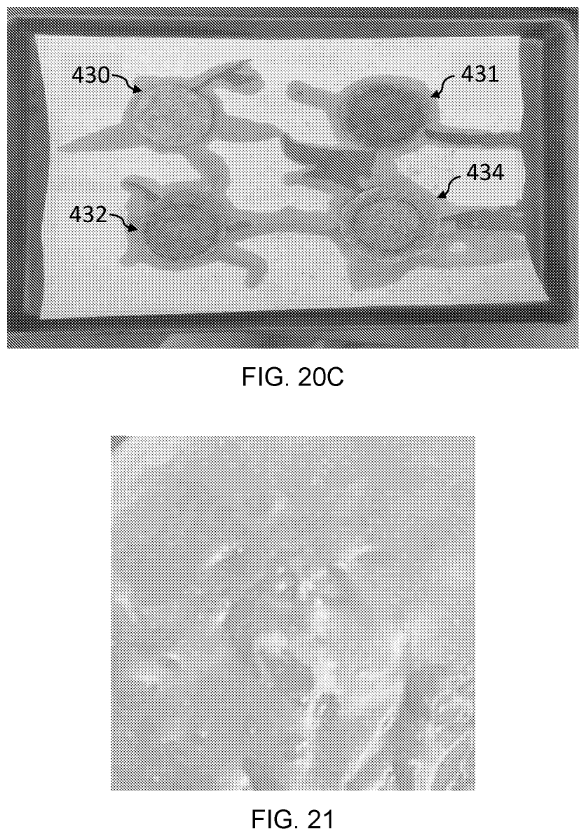

FIG. 20A shows the slices before heating. FIG. 20B shows the slices after heating, and FIG. 20C shows the slices after 30 minutes of cooling. As shown by FIG. 20A and FIG. 20B, example 430 had very little spread, examples 431 and 432 had a spread of about 6.35 mm (about ¼ of an inch), and example 434 had a spread of about 12.7 mm (about ½ of an inch). As also shown in FIG. 20B, each of the examples had significant oil precipitation. As shown in FIG. 20C, after 30 minutes of cooling each of the examples had additional oil precipitation.

### Example 12

Additional examples of plant-based cheese products (examples 500 to 514) were prepared. The example plant-based cheese products had the general formula shown in Tables 28 and 29 and were prepared with heating method “A” (described above in Example 11). A 1 M citric acid solution was added as the acidulant to each example plant-based cheese product in an amount effective to keep the pH below 5.5.

In these example plant-based cheese products, ethyl cellulose (EC) powder or a wax was combined with fat to make an oleogel.

To make the oleogels in examples 500 to 503, the oil (coconut oil) was heated to 36° C. to melt the oil. The EC powder or wax was added to the melted oil and homogenized at 4,000 rpm using a Polytron® handheld homogenizer (POLYTRON® PT 1300D V3, KINEMATICA) for 30 seconds.

To make the oleogels in examples 504 and 505, the oil (coconut oil) was heated to 36° C. to melt the oil, and the EC powder was added to the melted coconut oil. Then the combined EC powder and coconut oil was heated to dissolve the EC (indicated in Table 28 with the label “with Heat”). To make example 504, the combined EC powder and coconut oil mixture was heated to 133° C. before it was added to a 5% protein aqueous mixture. To make example 505, the EC powder and coconut oil mixture was heated to 133° C. and then cooled to 120° C. before it was added to a 5% protein aqueous mixture.

To make the oleogels in examples 506 to 514, the oil (coconut oil) was heated to 36° C. to melt the oil. The wax as added to the melted coconut oil, and the wax and coconut oil mixture underwent additional heating to melt the wax. The wax and coconut oil mixture was heated to 60-80° C. (depending on the wax used) and stirred.

To make examples 502 to 514, the 5% protein aqueous mixture was heated to temperature within ±2° C. of the temperature of the oleogel before the 5% protein aqueous mixture was combined with the oleogel.

The ethyl cellulose (EC) used was 45 cp ETHOCEL™ Standard 45 (The Dow Chemical Company, Michigan, USA) (referred to as 45 EC) or 20 cp ETHOCEL™ Standard 20 (The Dow Chemical Company, Michigan, USA) (referred to as 20 EC). The wax used was rice bran wax, sunflower wax, candelilla wax, white beeswax, or orange wax (each from KOSTER KEUNEN®, Watertown, Connecticut, USA).

The faba protein isolate was obtained from AGT Food & Ingredients (about 90% crude protein by weight of the isolate). The native waxy maize was Waxy No 1 obtained from Tate & Lyle. The coconut oil was refined, organic, non-GMO coconut oil (Nutiva® Nurture Vitality™, Nutiva Inc., Richmond, CA).

Each of the formulas is shown in Table 28 or Table 29, with the wt % of each ingredient that was used (based on the total weight of the plant-based cheese product). The amount of the EC or wax indicated was based on the total weight of the fat.

TABLE 28

| | Specific | 500 | 501 | 502 | 503 | 504 | 505 | 506 | 507 |
|---|---|---|---|---|---|---|---|---|---|
| Ingredient | Component | (wt %) | (wt %) | (wt %) | (wt %) | (wt %) | (wt %) | (wt %) | (wt %) |
| Plant- | Faba | 18 | 18 | 18 | 18 | 18 | 18 | 18 | 18 |
| based | Protein | | | | | | | | |
| Protein | Isolate | | | | | | | | |
| Waxy | Native | 12 | 12 | 12 | 12 | 12 | 12 | 12 | 12 |
| Starch | Waxy | | | | | | | | |
| | Maize | | | | | | | | |
| Fat | 1% 20 EC in | 21 | — | — | — | — | — | — | — |
| | Coconut Oil | | | | | | | | |
| | 1% 45 EC in | — | 21 | — | — | — | — | — | — |
| | Coconut Oil | | | | | | | | |
| | 0.5% 20 EC | — | — | 21 | — | — | — | — | — |
| | in Coconut | | | | | | | | |
| | Oil | | | | | | | | |
| | 0.5% 45 EC | — | — | — | 21 | — | — | — | — |
| | in Coconut | | | | | | | | |
| | Oil | | | | | | | | |
| | 1% 20 EC in | — | — | — | — | 21 | — | — | — |
| | Coconut Oil | | | | | | | | |
| | with Heat | | | | | | | | |
| | 1% 45 EC in | — | — | — | — | — | 21 | — | — |
| | Coconut Oil | | | | | | | | |
| | with Heat | | | | | | | | |
| | 1% Rice | — | — | — | — | — | — | 21 | — |
| | Bran Wax in | | | | | | | | |
| | Coconut Oil | | | | | | | | |
| | 2% Rice | — | — | — | — | — | — | — | 21 |
| | Bran Wax in | | | | | | | | |
| | Coconut Oil | | | | | | | | |
| Water | Water | 49 | 49 | 49 | 49 | 49 | 49 | 49 | 49 |

TABLE 29

| | Specific | 508 | 509 | 510 | 511 | 512 | 513 | 514 |
|---|---|---|---|---|---|---|---|---|
| Ingredient | Component | (wt %) | (wt %) | (wt %) | (wt %) | (wt %) | (wt %) | (wt %) |
| Plant- | Faba | 18 | 18 | 18 | 18 | 18 | 18 | 18 |
| based | Protein | | | | | | | |
| Protein | Isolate | | | | | | | |
| Waxy | Native | 12 | 12 | 12 | 12 | 12 | 12 | 12 |
| Starch | Waxy | | | | | | | |
| | Maize | | | | | | | |
| Fat | 1% | 21 | — | — | — | — | — | — |
| | Sunflower | | | | | | | |
| | Wax in | | | | | | | |
| | Coconut Oil | | | | | | | |
| | 1% | — | 21 | — | — | — | — | — |
| | Candelilla | | | | | | | |
| | Wax in | | | | | | | |
| | Coconut Oil | | | | | | | |
| | 1% White | — | — | 21 | — | — | — | — |
| | Beeswax in | | | | | | | |
| | Coconut Oil | | | | | | | |
| | 1% Orange | — | — | — | 21 | — | — | — |
| | Wax in | | | | | | | |
| | Coconut Oil | | | | | | | |
| | 2% White | — | — | — | — | 21 | — | — |
| | Beeswax in | | | | | | | |
| | Coconut Oil | | | | | | | |
| | 2% Orange | — | — | — | — | — | 21 | — |
| | Wax in | | | | | | | |
| | Coconut Oil | | | | | | | |
| | 2% | — | — | — | — | — | — | 21 |
| | Sunflower | | | | | | | |
| | Wax in | | | | | | | |
| | Coconut Oil | | | | | | | |
| Water | Water | 49 | 49 | 49 | 49 | 49 | 49 | 49 |

The texture of examples 500 to 514 was evaluated as each example was transferred from thermomixer to a container for cooling. After the examples cooled to 5° C., the cold texture of each of the examples 500 to 514 was assessed.

In example 500 (1% 20 EC in coconut oil), the EC did not mix well into the product and the resulting mixture was not homogeneous. Example 500 was very viscous with white EC specs. For this and other samples including white EC specs after mixing, the resulting plant- based cheese products may not be receiving the full functional benefit of the EC due to the lack of incorporation. After cooling, example 500 did not cut easily. It was very crumbly and brittle.

In example 501 (1% 45 EC in coconut oil), the EC did not go into solution well, leaving about 80% of the EC unhomogenized. Example 501 was very thick with white EC specs. The cold texture of example 501 was similar to the cold texture of example 500. It was brittle and hard to cut.

In example 502 (0.5% 20 EC in coconut oil), the EC did not mix well into the product and the resulting mixture was not homogeneous. Example 502 had a mid-range viscosity with white EC specs. After cooling, example 502 produced a good disc cut and was less brittle than example 500 and 501.

In example 503 (0.5% 45 EC in coconut oil), the EC did not go into solution well, leaving about 60% of the EC unhomogenized. Example 503 was sticky and viscous with white EC specs. The cold texture of example 503 was soft, cut cleanly, and had a smooth top.

In example 504 (1% 20 EC in coconut oil with heat), the EC and coconut oil mixture gelled when homogenized. The gel was thick, sticky, and viscous and did not have EC specs. However, the mixture separated after homogenization with the plant-based protein and starch. The mixture was reincorporated after the second addition of the plant-based protein and starch. The cold texture of example 504 was very smooth and cut cleanly. It produced a great disc cut and was much less brittle than examples 500 to 503. Example 504 was considered a successful formulation.

In example 505 (1% 45 EC in coconut oil with heat), the EC and coconut oil mixture did not have EC specs and did not have the separation exhibited in example 504. The cold texture of example 505 was similar to the cold texture of example 504. It was very smooth and cut cleanly. It produced a great disc cut and was much less brittle than examples 500 to 503. Example 505 was considered a successful formulation.

In example 506 (1% rice bran wax in coconut oil), the EC and coconut oil mixture was thinner that the EC and coconut oil mixture in examples 500 and 501. The cold texture of example 506 was difficult to cut and was slightly crumbly and brittle. Example 506 was considered a successful formulation.

In example 507 (2% rice bran wax in coconut oil), the wax and coconut oil mixture had a consistency similar to the EC and coconut oil mixture in example 503. Homogenization with the 5% protein aqueous mixture was better when the 5% protein aqueous mixture was the same temperature as the wax and coconut oil mixture. However, the 5% protein aqueous mixture began to evaporate and concentrate above 40° C. The cold texture of example 507 was similar to the cold texture of example 506 but was more brittle. Its cutability was mediocre. Example 507 was considered a successful formulation.

In example 508 (1% sunflower wax in coconut oil), the sunflower wax took a higher temperature (75° C.) to melt. The wax and coconut oil mixture did not gel and was very thick with a consistency similar to the EC and coconut oil mixture in example 505. Homogenization with the plant-based protein and starch was successful (i.e., crystallization did not occur) when 5% protein aqueous mixture was the same temperature as the wax and coconut oil mixture. After cooling, example 508 produced an excellent disc cut and was less brittle than examples 506 and 507. Example 508 was considered a successful formulation.

In example 509 (1% candelilla wax in coconut oil), the candelilla wax melted at 74° C. The wax and coconut oil mixture did not gel and was not thick but was very sticky and glossy. Homogenization with the plant-based protein and starch was successful (i.e., crystallization did not occur) when 5% protein aqueous mixture was the same temperature as the wax and coconut oil mixture. After cooling, example 509 produced a good disc cut, was the least brittle of examples 506 to 514, and resembled natural cheese. Example 509 was considered a successful formulation.

In example 510 (1% white beeswax in coconut oil), the white beeswax melted at 70° C. The wax and coconut oil mixture was very similar to the wax and coconut oil mixture of example 509. It did not gel and was not thick but was very sticky and glossy. Homogenization with the plant-based protein and starch was successful (i.e., crystallization did not occur) when 5% protein aqueous mixture was the same temperature as the wax and coconut oil mixture. After cooling, example 510 produced an excellent disc cut and was very soft but brittle on the edges. Example 510 was considered a particularly beneficial formulation.

In example 511 (1% orange wax in coconut oil), the wax and coconut oil mixture was less dense than the wax and coconut oil mixtures of the other examples. Example 511 was very runny and thin. After cooling, example 511 produced the best disc cut of examples 506 to 514, was extremely soft, and was the most like a natural cheese of examples 506 to 514. Example 511 was considered a particularly beneficial formulation.

In example 512 (2% white beeswax in coconut oil), the wax and coconut oil mixture combined well with the 5% protein aqueous mixture at 70° C. Homogenization made the mixture look like milk. Clumps formed and went away with mixing. Example 512 was very thick, very sticky and shiny and was less sticky than example 510. The cold texture of example 512 was slightly brittle. Example 512 was considered a successful formulation.

In example 513 (2% orange wax in coconut oil), the orange wax was easily added to the coconut oil (as compared to the other waxes). Example 513 was thin and oily. It was thicker than example 511 and less oily than example 512. The cold texture of example 513 was brittle and the sample crumbled several times during cutting. Example 513 was considered a successful formulation.

In example 514 (2% sunflower wax in coconut oil), the sunflower wax gelled if the wax was not kept above 75° C. The wax and coconut oil mixture homogenized well. Clumps formed and went away with mixing. Example 514 was glossy, thick, and denser than example 508. The cold texture of example 514 was slightly brittle. It was less brittle that example 513 but more brittle than example 512. Example 514 was considered a particularly beneficial formulation.

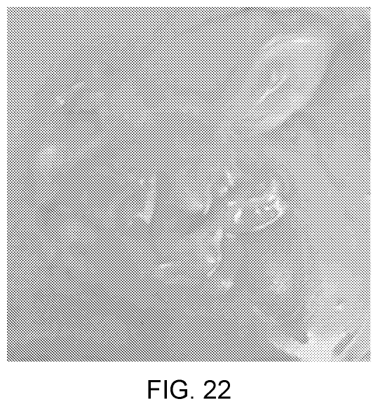

As described above, examples 500 to 503 had white EC specs, and examples 504 and 505 did not have EC specs. FIG. 21 shows example 501 (1% 45 EC in coconut oil), which had white EC specs. FIG. 22 shows example 504 (1% 20 EC in coconut oil with heat), which did not have specs. Additionally, examples 506 to 514 did not have specs of wax. As such, these examples indicate that it is beneficial to heat the mixture of oil and EC or wax to fully incorporate the EC or wax in the oil.

An additional example of the plant-based cheese product (example 410) was prepared. The example plant-based cheese product had the general formula shown in Table 30 and was prepared with heating method “A” (described above in Example 11). A 1 M citric acid solution was added as the acidulant to the example plant-based cheese product in an amount effective to keep the pH below 5.5.

In this example plant-based cheese product, coconut oil alone was used as the fat.

The faba protein isolate was obtained from AGT Food & Ingredients (about 90% crude protein by weight of the isolate). The native waxy maize was Waxy No 1 obtained from Tate & Lyle. The coconut oil was refined, organic, non-GMO coconut oil (Nutiva® Nurture Vitality™, Nutiva Inc., Richmond, CA).

The formula is shown in Table 30, with the wt % of each ingredient that was used (based on the total weight of the plant-based cheese product).

TABLE 30

| | Specific | 410 |
|---|---|---|
| Ingredient | Component | (wt %) |
| Plant-based | Faba Protein | 18 |
| Protein | Isolate | |
| Waxy | Native Waxy | 12 |
| Starch | Maize | |
| Fat | Coconut Oil | 21 |
| Water | Water | 49 |

The melt percentage of the example plant-based cheese products were measured according to the Second Schreiber Test (described above in Example 11). The results of the melt percentage measurements are shown in Table 31.

TABLE 31

| (Melt Percentage in %) | |
|---|---|
| | Second |
| | Schreiber Test |
| 410 (Coconut Oil) | 58% |
| 500 (1% 20 EC in | 30% |
| Coconut Oil) | |
| 501 (1% 45 EC in | 35% |
| Coconut Oil) | |
| 502 (0.5% 20 EC in | 13% |
| Coconut Oil) | |
| 503 (0.5% 45 EC in | 30% |
| Coconut Oil) | |
| 504 (1% 20 EC in | 36% |
| Coconut Oil with Heat) | |
| 505 (1% 45 EC in | 1% |
| Coconut Oil with Heat) | |
| 506 (1% Rice Bran Wax in | 43% |
| Coconut Oil) | |
| 507 (2% Rice Bran Wax in | 36% |
| Coconut Oil) | |
| 508 (1% Sunflower Wax | 39% |
| in Coconut Oil) | |
| 509 (1% Candelilla Wax | 27% |
| in Coconut Oil) | |
| 510 (1% White Beeswax | 41% |
| in Coconut Oil) | |
| 511 (1% Orange Wax in | 45% |
| Coconut Oil) | |
| 512 (2% White Beeswax | 49% |
| in Coconut Oil) | |
| 513 (2% Orange Wax in | 42% |
| Coconut Oil) | |
| 514 (2% Sunflower Wax | 72% |
| in Coconut Oil) | |

As shown in Table 31, the examples that included white beeswax or orange wax (Examples 510 to 513) had a high melt percentage, which was similar to the melt percentage of example 410 (coconut oil). As also shown in Table 31, example 514 (2% sunflower wax in coconut oil) had a melt percentage that was higher than the melt percentage of example 410 (coconut oil). Additionally, Table 31 shows that increasing the level of sunflower wax in the oleogel from 1% (example 508) to 2% (example 514) significantly improves the melt percentage.

Overall, Table 31 shows that examples 506 (1% rice bran wax in coconut oil), 510 (1% white beeswax in coconut oil), 511 (1% orange wax in coconut oil), and 514 (2% sunflower wax in coconut oil) had the good melt performance.

In the Schreiber test, example 506 (1% rice bran wax in coconut oil) had an even melt and slightly uneven oiling off. After cooling, example 506 had a soft texture.

In the Schreiber test, example 510 (1% white beeswax in coconut oil) had a very even melt and low oiling off after melting. However, example 510 had higher oiling off 30 minutes after melting. After cooling, example 510 had good stretch/pull.

In the Schreiber test, example 511 (1% orange wax in coconut oil) had a very even melt and low oiling off after melting and 30 minutes after melting. After cooling, example 511 had good stretch/pull.

In the Schreiber test, example 514 (2% sunflower wax in coconut oil) had the largest visual spread and a very even melt. Example 514 had the longest stretching texture after cooling (as compared to the stretching texture after cooling of examples 500 to 513). The stretching texture was assessed by hand stretching the samples.

As shown above, the amount and type of oleogelator can be selected to achieve desired melt performance.

### Prophetic Example 13

Additional examples of the plant-based cheese product (examples 515 to 532) including an oleogel can be prepared. The example plant-based cheese products have the general formula shown in Tables 32 through 34 and are prepared with heating method “A” (described above in Example 11). A 1 M citric acid solution is added as the acidulant to each example plant-based cheese product in an amount effective to keep the pH below 5.5.

In these example plant-based cheese products, ethyl cellulose (EC), a wax, bentonite clay, soy lecithin, mucilage, or fenugreek gum is used to make an oleogel. To make the oleogels, the oil (e.g., coconut oil) may be heated to temperature of 36° C. to melt the oil. The organogelator may be added to the melted oil or room temperature (20° C.) oil. The mixture is heated, if needed, to melt/disperse the organogelator. Then, the mixture is homogenized, such as at 4,000 rpm using a Polytron® handheld homogenizer (POLYTRON® PT 1300D V3, KINEMATICA) for 30 seconds. The ethyl cellulose (EC) used may be 20 cp ETHOCEL™ Standard 20 (The Dow Chemical Company, Michigan, USA) (referred to as 20 EC). The wax used may be candelilla wax (KOSTER KEUNEN®, Watertown, Connecticut, USA) or propolis wax.

The faba protein isolate may be obtained from AGT Food & Ingredients (about 90% crude protein by weight of the isolate). The faba protein concentrate may be obtained from Ingredion (about 60% crude protein by weight of the concentrate). The chickpea protein concentrate may be obtained from Nutriati (about 60% crude protein by weight of the concentrate). The native waxy maize may be Waxy No 1 obtained from Tate & Lyle. The coconut oil may be refined, organic, non-GMO coconut oil (Nutiva® Nurture Vitality™, Nutiva Inc., Richmond, CA).

Each of the formulas is shown in Table 32 through Table 34, with the wt % of each ingredient that may be used (based on the total weight of the plant-based cheese product). The amount of the EC, wax, bentonite clay, soy lecithin, mucilage, or fenugreek gum indicated is based on the total weight of the fat. Each of the examples 515 to 532 is expected to provide a plant-based cheese formulation having good stretch and melt characteristics.

TABLE 32

| | Specific | 515 | 516 | 517 | 518 | 519 | 520 | 521 | 522 |
|---|---|---|---|---|---|---|---|---|---|
| Ingredient | Component | (wt %) | (wt %) | (wt %) | (wt %) | (wt %) | (wt %) | (wt %) | (wt %) |
| Plant- | Faba | 18 | — | — | — | — | 18 | — | 18 |
| based | Protein | | | | | | | | |
| Protein | Isolate | | | | | | | | |
| | Faba | — | 18 | — | 18 | — | — | 18 | — |
| | Protein | | | | | | | | |
| | Concentrate | | | | | | | | |
| | Chickpea | — | — | 18 | — | 18 | — | — | — |
| | Protein | | | | | | | | |
| | Concentrate | | | | | | | | |
| Waxy | Native | 12 | 12 | 12 | 12 | 12 | 12 | 12 | 12 |
| Starch | Waxy | | | | | | | | |
| | Maize | | | | | | | | |
| Fat | 2% | 21 | — | — | — | — | — | — | — |
| | Candelilla | | | | | | | | |
| | Wax in | | | | | | | | |
| | Coconut Oil | | | | | | | | |
| | 1% 20 EC in | — | 21 | 21 | 21 | 21 | — | — | — |
| | Coconut Oil | | | | | | | | |
| | with Heat | | | | | | | | |
| | 1% | — | — | — | — | — | 21 | 21 | — |
| | Bentonite | | | | | | | | |
| | Clay in | | | | | | | | |
| | Coconut Oil | | | | | | | | |
| | 2% | — | — | — | — | — | — | — | 21 |
| | Bentonite | | | | | | | | |
| | Clay in | | | | | | | | |
| | Coconut Oil | | | | | | | | |
| Water | Water | 49 | 49 | 49 | 49 | 49 | 49 | 49 | 49 |

TABLE 33

| | Specific | 523 | 524 | 525 | 526 | 527 | 528 | 529 | 530 |
|---|---|---|---|---|---|---|---|---|---|
| Ingredient | Component | (wt %) | (wt %) | (wt %) | (wt %) | (wt %) | (wt %) | (wt %) | (wt %) |
| Plant- | Faba | 18 | 18 | — | — | 18 | 18 | 18 | 18 |
| based | Protein | | | | | | | | |
| Protein | Isolate | | | | | | | | |
| | Faba | — | — | 18 | — | — | — | — | — |
| | Protein | | | | | | | | |
| | Concentrate | | | | | | | | |
| | Chickpea | — | — | — | 18 | — | — | — | — |
| | Protein | | | | | | | | |
| | Concentrate | | | | | | | | |
| Waxy | Native | 10 | 12 | 12 | 12 | 12 | 12 | 12 | 12 |
| Starch | Waxy | | | | | | | | |
| | Maize | | | | | | | | |
| | OSA Potato | 2 | — | — | — | — | — | — | |
| | Starch | | | | | | | | |
| Fat | 2% | 21 | | | | — | — | — | — |
| | Bentonite | | | | | | | | |
| | Clay in | | | | | | | | |
| | Coconut Oil | | | | | | | | |
| | 1% Soy | — | 21 | 21 | 21 | — | — | — | — |
| | Lecithin in | | | | | | | | |
| | Coconut Oil | | | | | | | | |
| | 1% Propolis | — | — | — | — | 21 | — | — | — |
| | Wax in | | | | | | | | |
| | Coconut Oil | | | | | | | | |
| | 2% Propolis | — | — | — | — | — | 21 | — | — |
| | Wax in | | | | | | | | |
| | Coconut Oil | | | | | | | | |
| | 0.5% | — | — | — | — | — | — | 21 | — |
| | Mucilage in | | | | | | | | |
| | Coconut Oil | | | | | | | | |
| | 1% | — | — | — | — | — | — | — | 21 |
| | Fenugreek | | | | | | | | |
| | Gum in | | | | | | | | |
| | Coconut Oil | | | | | | | | |
| Water | Water | 49 | 49 | 49 | 49 | 49 | 49 | 49 | 49 |

TABLE 34

| | Specific | 531 | 532 |
|---|---|---|---|
| Ingredient | Component | (wt %) | (wt %) |
| Plant- | Faba | 18 | — |
| based | Protein | | |
| Protein | Isolate | | |
| | Faba | — | 18 |
| | Protein | | |
| | Concentrate | | |
| Waxy | Native | 12 | 12 |
| Starch | Waxy | | |
| | Maize | | |
| Fat | 1% 20 EC in | 21 | 21 |
| | Coconut Oil | | |
| | with Heat | | |
| Water | Water | 49 | 49 |

### Aspects

In a first aspect, the present disclosure pertains to a plant-based cheese product comprising: a plant-based protein present in an amount within the range of about 10 wt % to about 25 wt % crude protein, based on a total weight of the plant-based cheese product; a waxy starch comprising at least 70 wt % amylopectin, based on a total weight of the waxy starch, wherein the waxy starch is at least partially gelatinized; and a fat.

In a second aspect, the present disclosure pertains to the plant-based cheese product of the first aspect, further comprising an acidulant in an amount effective to provide a pH of the plant-based cheese product of about 4.5 to about 5.5.

In a third aspect, the present disclosure pertains to the plant-based cheese product of the second aspect, wherein the acidulant comprises one or more of citric acid, malic acid, acetic acid, phosphoric acid, sorbic acid, and lactic acid.

In a fourth aspect, the present disclosure pertains to the plant-based cheese product of any one of the first aspect to the third aspect, further comprising a wax having a melting point less than 80° C.

In a fifth aspect, the present disclosure pertains to the plant-based cheese product of the fourth aspect, wherein the wax comprises one or more of orange wax, rice bran wax, sunflower wax, beeswax, and candelilla wax.

In a sixth aspect, the present disclosure pertains to the plant-based cheese product of the fourth aspect, wherein the wax comprises candelilla wax.

In a seventh aspect, the present disclosure pertains to the plant-based cheese product of any one of the fourth aspect to the sixth aspect, wherein the wax is present in an amount within the range of about 0.5 wt % to about 5 wt %, based on the total weight of the fat.

In an eighth aspect, the present disclosure pertains to the plant-based cheese product of any one of the first aspect to the seventh aspect, further comprising ethyl cellulose.

In a ninth aspect, the present disclosure pertains to the plant-based cheese product of the eighth aspect, wherein the ethyl cellulose is present in an amount within the range of about 0.1 wt % to about 2 wt %, based on the total weight of the fat.

In a tenth aspect, the present disclosure pertains to the plant-based cheese product of any one of the first aspect to the ninth aspect, wherein the plant-based protein is present in an amount of about 14 wt % to about 20 wt % crude protein, based on a total weight of the plant-based cheese product.

In an eleventh aspect, the present disclosure pertains to the plant-based cheese product of any one of the first aspect to the tenth aspect, wherein the plant-based protein comprises one or more of faba protein, chickpea protein, mungbean protein, soy protein, zein protein, lupin protein, canola protein, pea protein, lentil protein and flax protein.

In a twelfth aspect, the present disclosure pertains to the plant-based cheese product of any one of the first aspect to the eleventh aspect, wherein the plant-based protein comprises faba protein.

In a thirteenth aspect, the present disclosure pertains to the plant-based cheese product of any one of the first aspect to the twelfth aspect, wherein the waxy starch is present in an amount within the range of about 5 wt % to about 20 wt %, based on the total weight of the plant-based cheese product.

In a fourteenth aspect, the present disclosure pertains to the plant-based cheese product of any one of the first aspect to the twelfth aspect, wherein the waxy starch is present in an amount within the range of about 12 wt % to about 16 wt %, based on the total weight of the plant-based cheese product.

In a fifteenth aspect, the present disclosure pertains to the plant-based cheese product of any one of the first aspect to the fourteenth aspect, wherein the waxy starch comprises native waxy maize.

In a sixteenth aspect, the present disclosure pertains to the plant-based cheese product of any one of the first aspect to the fifteenth aspect, wherein the fat is present in an amount within the range of about 15 wt % to about 30 wt %, based on the total weight of the plant-based cheese product.

In a seventeenth aspect, the present disclosure pertains to the plant-based cheese product of any one of the first aspect to the fifteenth aspect, wherein the fat is present in an amount within the range of about 19 wt % to about 27 wt %, based on the total weight of the plant-based cheese product.

In an eighteenth aspect, the present disclosure pertains to the plant-based cheese product of any one of the first aspect to the fifteenth aspect, wherein the fat is present in an amount of about 20 to about 25 wt %, based on the total weight of the plant-based cheese product.

In a ninteenth aspect, the present disclosure pertains to the plant-based cheese product of any one of the first aspect to the eighteenth aspect, wherein the fat comprises one or more of coconut oil, shea oil, shea stearin, shea olein, shea butter, palm oil, palm oil fraction, sunflower oil, cocoa butter and cottonseed glycerolysis.

In a twentieth aspect, the present disclosure pertains to the plant-based cheese product of any one of the first aspect to the eighteenth aspect, wherein the fat comprises coconut oil.

In a twenty-first aspect, the present disclosure pertains to the plant-based cheese product of any one of the first aspect to the twentieth aspect, wherein the plant-based cheese product has a hardness within the range of about 19 N to about 21 N, when compressing the plant-based cheese product by 50%.

In a twenty-second aspect, the present disclosure pertains to the plant-based cheese product of any one of the first aspect to the twentieth aspect, wherein the plant-based cheese product has a hardness within the range of about 76 N to about 90 N, when compressing the plant-based cheese product by 50%.

In a twenty-third aspect, the present disclosure pertains to the plant-based cheese product of any one of the first aspect to the twenty-second aspect, wherein the plant-based cheese product has a melt percentage within the range of about 65% to about 185%.

In a twenty-fourth aspect, the present disclosure pertains to the plant-based cheese product of any one of the first aspect to the twenty-second aspect, wherein the plant-based cheese product has a melt percentage within the range of about 80% to about 185%.

In a twenty-fifth aspect, the present disclosure pertains to the plant-based cheese product of any one of the first aspect to the twenty-first aspect, wherein the plant-based cheese product has a melt percentage of about 98% to about 185%.

In a twenty-sixth aspect, the present disclosure pertains to the plant-based cheese product of any one of the first aspect to the twentieth aspect, wherein the plant-based cheese product has a melt percentage of about 110% to about 185%.

In a twenty-seventh aspect, the present disclosure pertains to the plant-based cheese product of any one of the first aspect to the twenty-second aspect, wherein the plant-based cheese product has a melt percentage within the range of about 65% to about 155%.

In a twenty-eighth aspect, the present disclosure pertains to the plant-based cheese product of any one of the first aspect to the twenty-second aspect, wherein the plant-based cheese product has a melt percentage within the range of about 80% to about 155%.

In a twenty-ninth aspect, the present disclosure pertains to the plant-based cheese product of any one of the first aspect to the twenty-first aspect, wherein the plant-based cheese product has a melt percentage of about 98% to about 155%.

In a thirtieth aspect, the present disclosure pertains to the plant-based cheese product of any one of the first aspect to the twentieth aspect, wherein the plant-based cheese product has a melt percentage of about 110% to about 155%.

In a thirty-first aspect, the present disclosure pertains to the plant-based cheese product of any one of the first aspect to the thirtieth aspect, wherein the plant-based cheese product has an oil loss of 6 or less.

In a thirty-second aspect, the present disclosure pertains to the plant-based cheese product of any one of the first aspect to the thirtieth aspect, wherein the plant-based cheese product has an oil loss of 4 or less.

In a thirty-third aspect, the present disclosure pertains to the plant-based cheese product of any one of the first aspect to the thirtieth aspect, wherein the plant-based cheese product has an oil loss of 2 or less.

In a thirty-fourth aspect, the present disclosure pertains to the plant-based cheese product of any one of the first aspect to the thirtieth aspect, wherein the plant-based cheese product has an oil loss of 1 or less.

In a thirty-fifth aspect, the present disclosure pertains to the plant-based cheese product of any one of the first aspect to the thirtieth aspect, wherein the plant-based cheese product has an oil loss of 0.

In a thirty-sixth aspect, the present disclosure pertains to the plant-based cheese product of any one of the first aspect to the thirty-fifth aspect, wherein the plant-based cheese product has a Tan δ value greater than 0.4 at 80° C.

In a thirty-seventh aspect, the present disclosure pertains to the plant-based cheese product of any one of the first aspect to the thirty-fifth aspect, wherein the plant-based cheese product has a Tan δ value greater than 0.6 at 80° C.

In a thirty-eighth aspect, the present disclosure pertains to the plant-based cheese product of any one of the first aspect to the thirty-fifth aspect, wherein the plant-based cheese product has a Tan δ value greater than 0.8 at 80° C.

In a thirty-ninth aspect, the present disclosure pertains to the plant-based cheese product of any one of the first aspect to the thirty-eighth aspect, wherein the plant-based cheese product has a stretch of at least 20 mm at 80° C.

In a fortieth aspect, the present disclosure pertains to the plant-based cheese product of any one of the first aspect to the thirty-eighth aspect, wherein the plant-based cheese product has a stretch of at least 25 mm at 80° C.

In a forty-first aspect, the present disclosure pertains to the plant-based cheese product of any one of the first aspect to the thirty-eighth aspect, wherein the plant-based cheese product has a stretch of at least 30 mm at 80° C.

In a forty-second aspect, the present disclosure pertains to the plant-based cheese product of any one of the first aspect to the thirty-eighth aspect, wherein the plant-based cheese product has a stretch of at least 35 mm at 80° C.

In a forty-third aspect, the present disclosure pertains to the plant-based cheese product of any one of the first aspect to the forty-second aspect, wherein the waxy starch comprises one or more of a tapioca starch and a casava starch.

In a forty-fourth aspect, the present disclosure pertains to the plant-based cheese product of any one of the first aspect to the eighth aspect or the twenty-first aspect to the forty-third aspect, wherein the fat comprises coconut oil and sunflower oil.

In a forty-fifth aspect, the present disclosure pertains to a method of making a plant-based cheese product, comprising: dissolving a first amount of a plant-based protein in an aqueous liquid to form an aqueous plant-based mixture; heating a fat to form a melted fat; emulsifying the aqueous plant-based protein mixture with the melted fat to form an emulsion; adding a second amount of the plant-based protein and a waxy starch to the emulsion and mixing to form a mixture; heating and mixing the mixture for a time effective to at least partially gelatinize the waxy starch to form a heated mixture; and cooling the heated mixture to form the plant-based cheese product; wherein the plant-based cheese product comprises about 10 wt % to about 25 wt % crude protein, based on a total weight of the plant-based cheese product; and wherein the waxy starch comprises at least 70 wt % amylopectin, based on a total weight of the waxy starch.

In a forty-sixth aspect, the present disclosure pertains to the method of the forty-fifth aspect, further comprising adding an acidulant to the emulsion or the mixture.

In a forty-seventh aspect, the present disclosure pertains to the method of the forty-sixth aspect, wherein the acidulant is added in an amount effective to provide a pH within the range of about 4.5 to about 5.5 in the plant-based cheese product.

In a forty-eighth aspect, the present disclosure pertains to the method of any one of the forty-fifth aspect to the forty-seventh aspect, further comprising adding a wax having a melting point less than 80° C. to the fat.

In a forty-ninth aspect, the present disclosure pertains to the method of any one of the forty-fifth aspect to the forty-eighth aspect, further comprising adding ethyl cellulose to the fat.

In a fiftieth aspect, the present disclosure pertains to the method of the forty-ninth aspect, further comprising forming an oleogel from the ethyl cellulose and the fat.

In a fifty-first aspect, the present disclosure pertains to the method of any one of the forty-fifth aspect to the fiftieth aspect, further comprising filling the heated mixture into a container prior to the cooling step.

In a fifty-second aspect, the present disclosure pertains to the method of any one of the forty-fifth aspect to the fifty-first aspect, wherein the aqueous plant-based protein mixture comprises from about 2% w/v to about 8% w/v of the plant-based protein.

In a fifty-third aspect, the present disclosure pertains to the method of any one of the forty-fifth aspect to the fifty-first aspect, wherein the aqueous plant-based protein mixture comprises from about 4% w/v to about 6% w/v of the plant-based protein.

In a fifty-fourth aspect, the present disclosure pertains to the method of any one of the forty-fifth aspect to the fifty-third aspect, wherein the heating of the fat is to a temperature within the range of about 35° C. to about 60° C.

In a fifty-fifth aspect, the present disclosure pertains to the method of any one of the forty-sixth aspect to the fifty-fourth aspect, wherein the acidulant comprises one or more of citric acid, malic acid, acetic acid, phosphoric acid, sorbic acid, and lactic acid.

In a fifty-sixth aspect, the present disclosure pertains to the method of any one of the forty-eighth aspect to the fifty-fifth aspect, wherein the wax comprises one or more of orange wax, rice bran wax, sunflower wax, beeswax, and candelilla wax.

In a fifty-seventh aspect, the present disclosure pertains to the method of any one of the forty-eighth aspect to the fifty-fifth aspect, wherein the wax comprises candelilla wax.

In a fifty-eighth aspect, the present disclosure pertains to the method of any one of the forty-fifth aspect to the fifty-seventh aspect, wherein the plant-based protein comprises faba protein.

In a fifty-ninth aspect, the present disclosure pertains to the method of any one of the forty-fifth aspect to the fifty-eighth aspect, wherein the waxy starch comprises native waxy maize.

In a sixtieth aspect, the present disclosure pertains to the method of any one of the forty-fifth aspect to the fifty-ninth aspect, wherein the fat comprises coconut oil.

In a sixty-first aspect, the present disclosure pertains to the method of any one of the forty-fifth aspect to the sixtieth aspect, wherein the waxy starch comprises one or more of a tapioca starch and a casava starch.

In a sixty-second aspect, the present disclosure pertains to the method of any one of the forty-fifth aspect to the fifty-ninth aspect or the sixty-first aspect, wherein the fat comprises coconut oil and sunflower oil.

It is to be understood that the ranges provided herein include the stated range and any value or sub-range within the stated range. For example, a range of about 10 wt % to about 25 wt % should be interpreted to include not only the explicitly recited limits of range of about 10 wt % to about 25 wt %, but also to include individual values, such as 12.35 wt %, 15.5 wt %, 18 wt %, 20.75 wt %, 23 wt %, etc., and sub-ranges, such as about 11 wt % to about 15.5 wt %, about 13.5 wt % to about 22.7 wt %, about 16.75 wt % to about 24 wt %, etc. Furthermore, when “about” is utilized to describe a value, this is meant to encompass minor variations (up to +/−10%) from the stated value.

All percentages and ratios are calculated by weight unless otherwise indicated. All percentages and ratios are calculated based on the total weight of the compound or composition unless otherwise indicated.

Reference throughout the specification to “an example,” “one example,” “another example,” “some examples,” “other examples,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

1-42. (canceled)

43. A plant-based cheese product comprising:
a plant-based protein present in an amount within the range of about 10 wt % to about 25 wt % crude protein, based on a total weight of the plant-based cheese product, wherein a portion of the protein is solubilized in the plant-based cheese product and another portion of the protein is dispersed in the plant-based cheese product;
a waxy starch comprising at least 65 wt % amylopectin, based on a total weight of the waxy starch, wherein the waxy starch is at least partially gelatinized; and
a fat in the form of droplets coated with the dispersed protein in the plant-based cheese product.

44. The plant-based cheese product as defined in claim 43, wherein the fat is one or more of coconut oil, shea oil, shea stearin, shea olein, shea butter, palm oil, palm oil fraction, sunflower oil, cocoa butter, and cottonseed glycerolysis.

45. The plant-based cheese product as defined in claim 43, further comprising an oleogelator.

46. The plant-based cheese product as defined in claim 43, wherein the oleogelator includes one or more of ethyl cellulose, wax, phytosterol, bentonite clay, soy lecithin, mucilage, and fenugreek gum.

47. The plant-based cheese product as defined in claim 46, wherein the wax includes one or more of orange wax, rice bran wax, sunflower wax, beeswax, propolis wax, and candelilla wax.

48. The plant-based cheese product as defined in claim 45, comprising about 15 wt % to about 30 wt % fat and about 0.1 wt % to about 5 wt % oleogelator.

49. The plant-based cheese product as defined in claim 43, wherein the gelatinized starch is at least 25% gelatinized.

50. (canceled)

51. (canceled)

52. The plant-based cheese product as defined in claim 43, wherein the waxy starch is present in an amount within the range of about 5 wt % to about 20 wt %, based on the total weight of the plant-based cheese product.

53. The plant-based cheese product as defined in claim 43, wherein the plant-based protein is present in an amount of about 14 wt % to about 20 wt % crude protein, based on a total weight of the plant-based cheese product.

54. The plant-based cheese product as defined in claim 43, wherein the plant-based protein comprises one or more of faba protein, chickpea protein, mungbean protein, soy protein, zein protein, lupin protein, canola protein, pea protein, lentil protein and flax protein.

55. The plant-based cheese product as defined in claim 43, wherein the plant-based cheese product has a Tan δ value greater than 0.3 at 80° C.

56. The plant-based cheese product as defined in claim 43, wherein the plant-based cheese product has a Tan δ value greater than 0.4 at 80° C.

57. A method of making a plant-based cheese product, comprising:
combining a first amount of a plant-based protein with an aqueous liquid to form an aqueous plant-based protein mixture;
combining an oleogelator with a fat;
heating the fat to form a melted fat, wherein the heating may occur before or after addition of the oleogelator;
heating the aqueous plant-based protein mixture to a temperature within about 20° C. of a temperature of the combination of melted fat and oleogelator;
emulsifying the plant-based protein mixture with the melted fat and oleogelator to form an emulsion;
adding a second amount of the plant-based protein and a waxy starch to the emulsion and mixing to form a second mixture;
heating and mixing the second mixture for a time effective to at least partially gelatinize the waxy starch to form a heated mixture; and
cooling the heated mixture to form the plant-based cheese product;
wherein the plant-based cheese product comprises about 10 wt % to about 25 wt % crude protein, based on a total weight of the plant-based cheese product; and
wherein the waxy starch comprises at least 65 wt % amylopectin, based on a total weight of the waxy starch.

58. The method as defined in claim 57, wherein the fat is one or more of coconut oil, shea oil, shea stearin, shea olein, shea butter, palm oil, palm oil fraction, sunflower oil, cocoa butter, and cottonseed glycerolysis.

59. The method as defined in claim 57, wherein the oleogelator includes one or more of ethyl cellulose, wax, phytosterol, bentonite clay, soy lecithin, mucilage, and fenugreek gum.

60. The method as defined in claim 57, wherein the wax includes one or more of orange wax, rice bran wax, sunflower wax, beeswax, propolis wax, and candelilla wax.

61. The method as defined in claim 57, comprising about 15 wt % to about 30 wt % fat and about 0.1 wt % to about 5 wt % oleogelator.

62. A plant-based cheese product prepared according to the method as defined in claim 57.

63. The plant-based cheese product as defined in claim 62, wherein the plant-based cheese product has a Tan δ value greater than 0.3 at 80° C.

64. (canceled)

65. (canceled)
